(19) United States
(12) Patent Application Publication
(10) Pub. No.: US 2022/0147570 A1
(43) Pub. Date: May 12, 2022

(54) INFORMATION PROCESSING APPARATUS AND INFORMATION PROCESSING METHOD

(71) Applicant: SONY GROUP CORPORATION, Tokyo (JP)

(72) Inventor: DAISUKE FUKUNAGA, TOKYO (JP)

(21) Appl. No.: 17/433,389

(22) PCT Filed: Dec. 19, 2019
(86) PCT No.: PCT/JP2019/049771

§ 371 Date: Aug. 24, 2021

(30) Foreign Application Priority Data
Mar. 4, 2019 (JP) 2019-039051
Oct. 2, 2019 (JP) 2019-182142

(51) Int. Cl. G06F 16/901

(52) U.S. Cl. CPC G06F 16/9024

(57) ABSTRACT

Provided is an information processing apparatus performing a huge-sized graph search process. The information processing apparatus includes an arithmetic operation unit, a first storage device, and a second storage device. Graph information is divided into two parts constituted by first graph information and second graph information, the first graph information is arranged in the first storage device, the second graph information is arranged in the second storage device, and the arithmetic operation unit executes a graph search process using the first graph information arranged in the first storage device and the second graph information arranged in the second storage device.

### TECHNICAL FIELD

A technology disclosed in the present description (hereinafter referred to as “present disclosure”) relates to an information processing apparatus and an information processing method for performing a graph search process.

### BACKGROUND ART

Some speech recognition uses a type of finite automaton called a WFST (Weighted Finite State Transducer) to calculate what text character string is contained in input speech sound. A model of the WFST is produced using text data collected for learning, or a corpus (a language material as a database of text and utterances collected on a large scale). A process for searching a WFST model (hereinafter also referred to as “WFST search” in the present description) is performed to search a most probable text character string for an input speech sound.

The WFST search is a type of graph search process. All WFSTs are usually loaded to a main storage device at the time of execution to achieve high-speed search (the main storage device referred to herein corresponds to a local memory (or a main memory) of a CPU, and will be hereinafter simply referred to as a “memory”). However, each of WFSTs handling a large vocabulary has a size ranging from several tens of GB to several hundreds of GB. Accordingly, a system having a large memory capacity is required to achieve an operation of the WFTS search. A use volume of the memory can be reduced when WFSTs are arranged in an auxiliary storage device (hereinafter also simply referred to as “disk”), such as an HDD (Hard Disc Drive) and an SSD (Solid State Drive) instead of the memory. However, performance of the disk such as an access speed and a throughput is lower than that of the memory. Accordingly, a time required for the WFTS search considerably increases.

Moreover, a many-core arithmetic unit constituted by many cores and capable of executing tasks in parallel, such as a GPU (Graphics Processing Unit), is used in some cases to achieve high-speed WFST search (e.g., see PTL 1). However, a typical many-core arithmetic unit such as a GPU has only a limited memory capacity.

### CITATION LIST

### Patent Literature

### [PTL 1]

JP 2015-529350 A

### [PTL 2]

JP 2017-527844 T

### Non-Patent Literature

### [NPL 1]

Mohri, M., Pereira, F. and Riley, M.: Weighted Finite-State Transducers in Speech Recognition, Computer Speech and Language, Vol. 16, No. 1, pp. 69-88 (2002)

### [NPL 2]

H. J. G. A. Dolfing, I. L. Hetherington, “Incremental language models for speech recognition using finite-state transducers,” Proc. of ASRU2001

### [NPL 3]

D. Willett, S. Katagiri, “Recent advances in efficient decoding combining on-line transducer composition and smoothed language model incorporation,” Proc. of ICASSP2002, Vol. I, pp. 713-716

### [NPL 4]

D. Willett, E. McDermott, Y. Minami, and S. Katagiri, “Time and Memory Efficient Viterbi Decoding for LVCSR Using a Precompiled Search Network,” Proc. of EUROSPEECH 2001-7th European Conference on Speech Communication and Technology

### [NPL 5]

P. R. Dixon, D. A. Caseiro, T. Oonishi, and S. Furui, “The Titech Large Vocabulary WFST Speech Recognition System,” 2007 IEEE Workshop on Automatic Speech Recognition & Understanding (ASRU)

### SUMMARY

### Technical Problem

An object of the technology according to the present disclosure is to provide an information processing apparatus and an information processing method for performing a huge-sized graph search process.

### Solution to Problem

A first aspect of the technology according to the present disclosure is directed to an information processing apparatus including an arithmetic operation unit, a first storage device, and a second storage device, in which graph information is divided into two parts constituted by first graph information and second graph information, the first graph information is arranged in the first storage device, the second graph information is arranged in the second storage device, and the arithmetic operation unit executes a graph search process using the first graph information arranged in the first storage device and the second graph information arranged in the second storage device.

Specifically, the graph information is a WFST model that represents an acoustic model, a pronunciation dictionary, and a language model of speech recognition. In addition, the first graph information is a small WFST model produced by synthesizing the acoustic model, the pronunciation dictionary, and a small part of two divided parts of the language model, the small part considering a connection of a first number of words or smaller. The second graph is a large WFST model that has a language model considering a connection of any number of words larger than the first number.

When reference to the second graph information is necessary during execution of a search process using the first graph information, the arithmetic operation unit copies a necessary part in the second graph information from the second storage device to the first storage device and continues the search process.

The arithmetic operation unit includes a first arithmetic operation unit including a GPU (Graphics Processing Unit) or a different type of many-core arithmetic unit, and a second arithmetic unit including a CPU (Central Processing Unit). The first storage device is a memory in the GPU. The second storage device is a local memory of the CPU. In addition, the first arithmetic operation unit causes transition of a token on a small WFST model. When state transition of a token on a large WFST model is needed as a result of output of a word from an arc to which the token has transited on the small WFST model, the first arithmetic operation unit performs an entire search process while copying data necessary for the process from the second storage device to the first storage device.

Alternatively, the arithmetic operation unit is constituted by a CPU or a GPU. The first storage device is a local memory of the arithmetic operation unit. The second storage device is an auxiliary storage device. In addition, the arithmetic operation unit causes transition of a token on a small WFST model. When state transition of a token on a large WFST model is necessary as a result of output of a word from an arc to which the token has transited on the small WFST model, the arithmetic operation unit performs the search process while copying data necessary for the process from the second storage device to the first storage device.

The large WFST model includes an arc array where arcs are sorted on the basis of a state ID of a source state and an input label. The first storage device includes arc indices that store start positions of arcs in respective states in the arc array as the data for accessing, and an input label array that stores input labels corresponding to the arcs in the arc array and arranged in an array identical to the arc array. In addition, the arithmetic operation unit specifies a position where a target arc in the arc array is stored, and acquires data of the target arc from the arc array of the second storage device by specifying a start position of a state ID of a source state of the target arc in the arc array on the basis of the arc indices, and searching an input label of the target arc on the basis of an element at the start position in the input label array.

Moreover, a second aspect of the technology according to the present disclosure is directed to an information processing method performed by an information processing apparatus that includes an arithmetic operation unit, a first storage device, and a second storage device, the information processing method including a step of arranging, in the first storage device, first graph information produced by dividing graph information, a step of arranging, in the second storage device, second graph information produced by dividing the graph information, and a step where the arithmetic operation unit executes a graph search process using the first graph information arranged in the first storage device and the second graph information arranged in the second storage device.

### Advantageous Effects of the Invention

The technology according to the present disclosure can provide an information processing apparatus and an information processing method for performing graph search in a memory-saving manner and at high speed by dividing huge-sized graph information into two parts, and arranging these parts separately in two storage areas.

Note that advantageous effects described in the present description are presented only by way of example, and advantageous effects produced by the technology according to the present disclosure are not limited to these advantageous effects. Moreover, the technology according to the present disclosure may further offer additional advantageous effects as well as the above advantageous effects.

Further objects, features, and advantages of the technology according to the present disclosure will become apparent in the light of more detailed description based on embodiments described below and the accompanying drawings.

### BRIEF DESCRIPTION OF DRAWINGS

FIG. 1 is a diagram depicting a configuration example of a speech recognition system 100.

FIG. 2 is a diagram depicting an example which divides a WFST model.

FIG. 3 is a diagram depicting a schematic configuration example of a speech recognition system 300 (first embodiment).

FIG. 4 is a diagram depicting a specific configuration example of the speech recognition system 300.

FIG. 5 is a flowchart presenting a general processing procedure for speech recognition executed by the speech recognition system 300.

FIG. 6 is a flowchart presenting a detailed processing procedure of a graph search process.

FIG. 7 is a diagram for explaining a method which sends information associated with necessary arcs from a GPU 320 to a CPU 310, and copies the information to a device memory 321 on the CPU 310 side.

FIG. 8 is a diagram depicting a mechanism for caching an arc of a large graph in the device memory 321 on the GPU 320 side.

FIG. 9 is a diagram depicting a configuration example of the speech recognition system 300 including a cache of the large graph.

FIG. 10 is a flowchart presenting a general processing procedure for speech recognition executed by the speech recognition system 300 depicted in FIG. 9.

FIG. 11 is a flowchart presenting a detailed processing procedure of a graph search process.

FIG. 12 is a diagram depicting a functional configuration example of an agent system 1200.

FIG. 13 is a diagram depicting a situation where arcs extend from a state.

FIG. 14 is a diagram depicting a relation between input and output of a language model WFST.

FIG. 15 is a diagram depicting a schematic configuration example of a speech recognition system 1500 (second embodiment).

FIG. 16 is a diagram depicting a configuration example of a speech recognition system 1500 where data for arc search is arranged in a memory.

FIG. 17 is a diagram depicting a configuration example of WFST (large) access data.

FIG. 18 is a diagram depicting another configuration example of WFST (large) access data.

FIG. 19 is a diagram depicting a specific functional configuration example of the speech recognition system 1500.

FIG. 20 is a flowchart presenting a general processing procedure for speech recognition executed by the speech recognition system 1500.

FIG. 21 is a flowchart presenting an example of a detailed processing procedure of a WFST search process.

FIG. 22 is a flowchart presenting another example of the detailed processing procedure of the WFST search process.

FIG. 23 is a flowchart presenting a processing procedure for specifying a page where a target arc is arranged in an arc array.

FIG. 24 is a diagram depicting a specific functional configuration example of the speech recognition system 1500 having an arc pre-reading function.

FIG. 25 is a flowchart presenting a detailed processing procedure for a WFST search process performed by the speech recognition system 1500 depicted in FIG. 24.

FIG. 26 is a flowchart presenting the detailed processing procedure for the WFST search process performed by the speech recognition system 1500 depicted in FIG. 24.

FIG. 27 is a diagram depicting a specific functional configuration example of a speech recognition system 2700.

FIG. 28 is a flowchart presenting a general processing procedure for speech recognition executed by the speech recognition system 2700.

### DESCRIPTION OF EMBODIMENTS

Embodiments of the technology according to the present disclosure will be hereinafter described in detail with reference to the drawings.

### A. Speech Recognition System

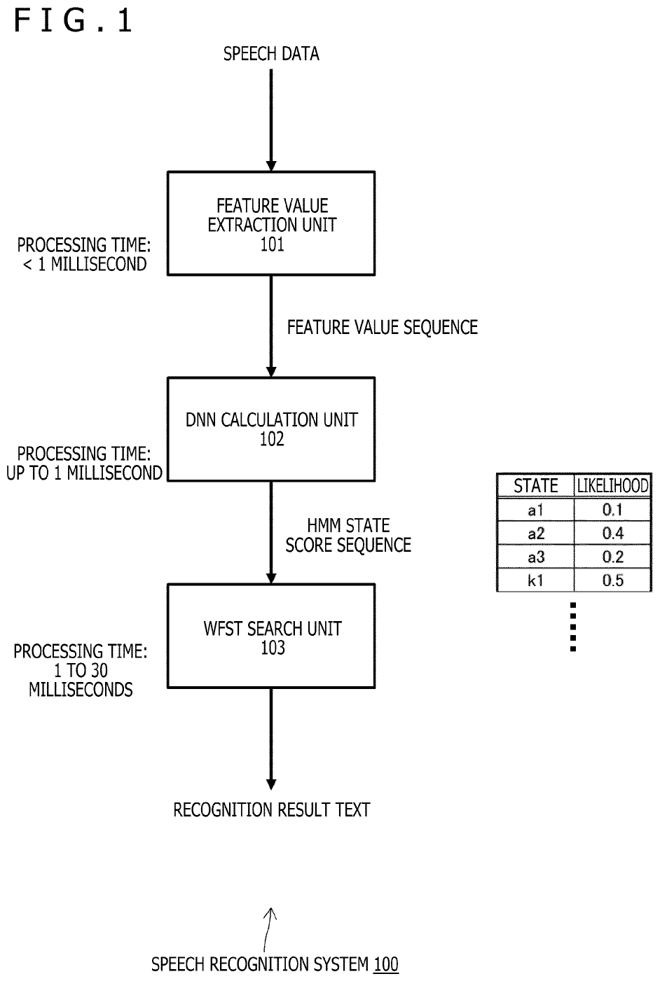

FIG. 1 depicts a schematic functional configuration example of a speech recognition system 100. The speech recognition system 100 depicted in the figure includes a feature value extraction unit 101, a DNN (Deep Neural Network) calculation unit 102, and a WFST search unit 103. It should be noted that not all speech recognition systems are configured as depicted in FIG. 1, and that speech recognition systems having other configurations may exist.

For example, speech data in units of ten milliseconds is input to the feature value extraction unit 101 from a speech input unit such as a microphone (not depicted). The feature value extraction unit 101 calculates feature values of the speech sound by applying Fourier transform to the input speech data, or using a mel filter bank or the like. For example, a processing time required by the feature value extraction unit 101 is shorter than one millisecond.

The DNN calculation unit 102 calculates scores (likelihoods) corresponding to respective states of an HMM (Hidden Markov Model) using a DNN model learned beforehand for the feature values extracted by the feature value extraction unit 101. For example, a processing time required by the DNN calculation unit 102 is approximately one millisecond.

The WFST search unit 103 calculates a most probable recognition result character string using a WFST model learned beforehand for the HMM state scores calculated by the DNN calculation unit 103, and outputs text indicating the recognition result. For example, a processing time required by the WFST search unit 103 is approximately in a range from one millisecond to 30 milliseconds.

### B. WFST in Speech Recognition

A WFST is a finite state machine having arcs to each of which information associated with an input symbol, an output symbol, and a weight (transition probability) is added. A typical speech recognition system is constituted by an acoustic model representing a phoneme and an acoustic feature, a pronunciation dictionary representing pronunciations of individual words, and a language model giving a grammar rule and a probability of a chain of words. Each of an HMM state transition used as the acoustic model, the pronunciation dictionary, and an N-gram model used as the language model can be represented by a WFST model. Moreover, the respective WFSTs of the acoustic model, the pronunciation dictionary, and the language model described above are unified into one huge WFST using a mathematically defined synthesis arithmetic operation to perform a speech recognition process (e.g., see NPL 1).

The WFST of the acoustic model has an input symbol corresponding to an HMM state, and an output symbol corresponding to a phoneme. The WFST of the pronunciation dictionary has an input symbol corresponding to a phoneme, and an output symbol corresponding to a word. The WFST of the language model has an input symbol and an output symbol each corresponding to a word. The language model is used to represent a transition probability of a connection between words. For example, the WFST produced by synthesizing the respective WFSTs of the acoustic model, the pronunciation dictionary, and the language model is configured to function as a network which has a phoneme string embedded in a word, and an HMM embedded in a phoneme. Moreover, the WFST after synthesis has an input symbol corresponding to an HMM state, and an output symbol corresponding to a word. In this manner, the speech recognition process finally arrives at a network search problem.

Basically, the WFST size increases as the vocabulary number (and the connection number of words to be considered) increases. Particularly, the size of the language model increases by exponentiation of the vocabulary number. In a case of a large vocabulary whose vocabulary number exceeds one million words, each of the number of the WFST states (nodes) and the number of arcs (edges) increases up to several billions. In this case, the vocabulary size becomes several tens of GB (e.g., the number of states: 12 billion, the number of arcs: 43 billion, and WFST size: 50 GB (12 GB after compression)).

The WFST search unit 103 searches a route most suited for input speech signals (optimum state transition process) within the WFST produced by synthesizing the respective WFSTs of the acoustic model, the pronunciation dictionary, and the language model, i.e., within the network, and decodes the input speech signals into word strings acoustically and linguistically suited for the input speech signals. The WFST search unit 103 is required to search optimum word strings at high speed.

### C. WFST Search Procedures

For example, procedures for WFST search are achieved in a following manner.

(Procedure 1)

An object (corresponding to a hypothesis of a recognition result) called a token (Token) which has a history of state transitions and information indicating accumulation of weights is positioned in an initial state of a WFST. The initial state is determined for each WFST beforehand.

(Procedure 2) The token on the WFST is caused to transit by one arc at the timing of reception of input data (HMM state score). At this time, a likelihood (score) of an HMM state corresponding to an input label of the arc, a weight of the arc, and accumulation of weights given to the token are multiplied to produce new weight accumulation. The likelihood of the HMM state corresponds to a probability resulting from input speech sound, while the weight of the arc corresponds to a probability resulting from a WFST model learned beforehand. In this manner, a most probable hypothesis is selected.

(Procedure 3)

In a case where tokens having reached the same state are present, only a token having the highest probability is retained, and the other tokens are discarded. This process is performed for reduction of the arithmetic operation volume.

(Procedure 4)

A token having a probability lower than the highest probability of the tokens by a beam width (setting value) or more is discarded. This process is performed for reduction of the arithmetic operation volume.

(Procedure 5)

The procedures 2 to 4 are repeatedly executed until input data ends (speech sound input ends).

(Procedure 6)

Output symbols of arcs arranged while tracing the history of the state transitions of the token having the highest probability are designated as a character string indicating a recognition result.

### D. Division of WFST and On-the-Fly Synthesis

In a case where one WFST is produced by synthesizing all the WFSTs of the acoustic model, the pronunciation dictionary, and the language model for speech recognition (described above), each of the number of states and the number of arcs increases on a multiplication basis. Accordingly, when each of the models before synthesis is relatively large, the model after synthesis inevitably becomes large-sized. Particularly, the size of the language model increases by an exponentiation of the vocabulary number (e.g., in a case of modeling a probability of appearance of a word D after appearance of words A, B, and C in this order, the language model considers a connection of these four words in a manner generally referred to as 4-gram). According to a large vocabulary whose vocabulary number exceeds one million words, each of the number of the WFST states (nodes) and the number of arcs (edges) increases up to several billions. In this case, the vocabulary size becomes several tens of GB.

The WFST search process frequently accesses information indicating a WFST model. Accordingly, a calculation speed considerably lowers unless the WFST model is decompressed in a memory. However, if the size of the WFST model excessively increases with an increase in the vocabulary number, the memory capacity runs short.

One of search methods for solving the problem that a WFST model has a huge size is a method called on-the-fly synthesis which divides a WFST model into two parts constituted by a large part and a small part, and synthesizes the two parts at the time of execution of speech recognition (e.g., see NPLs 2 and 3). The size of the WFST model increases after synthesis by multiplication of the sizes of the respective original WFST models. Accordingly, execution of on-the-fly synthesis can reduce the total size of the WFST models, i.e., can considerably reduce a memory use volume at the time of the search process.

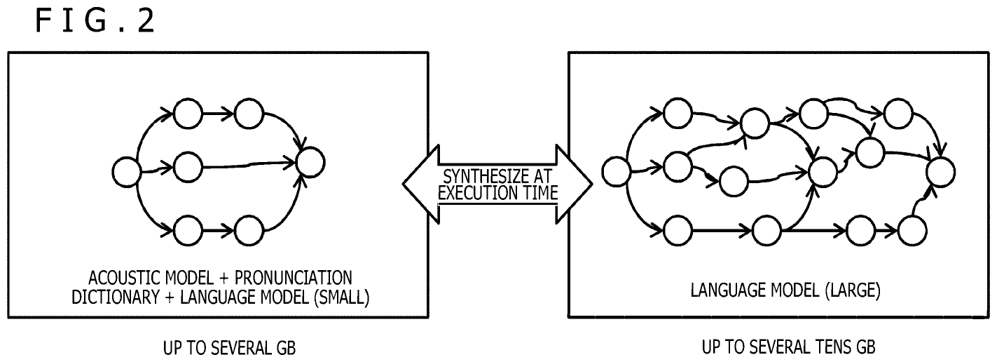

Particularly, a large-sized language model is divided into two parts constituted by a large part and a small part to divide a WFST into two parts. For example, division of the two parts is made such that a language model considering a connection between two words corresponds to the small part, and that a language model considering a connection of four words corresponds to the large part. Subsequently, as depicted in FIG. 2, a model produced by synthesizing an acoustic model, a pronunciation dictionary, and a small language model is designated as a small WFST model, and a large language model is designated as a large WFST model (or language model WFST). For example, the small WFST model has a size of approximately several GB, while the large WFST model has a size of approximately several tens of GB. Thereafter, a speech recognition process is executed while synthesizing the two WFST models constituted by the large and small WFST models as necessary. In this manner, considerable reduction of the memory capacity used at the time of search is achievable.

The on-the-fly synthesis causes transition of a token basically on the small WFST model, and causes a state transition of a token on the large WFST model only in a case where a word is output from an arc to which the token has transited on the small WFST model. The large WFST model only plays a role of considering a connection between words, and therefore causes transition only when a word is output. It is possible to consider a probability of a long connection of words, which connection is absent in the small WFST model, by multiplying the token by a transition probability of the large WFST model.

### E. Language Model

Speech recognition often uses N-gram as a language model. N-gram is a model which represents a probability of a connection between words using (N−1)-fold Markov process. In a case where the vocabulary number is V, V^{N} choices are present to represent a connection between N words. In this case, V^{N} arcs are required to represent these choices using a WFST. Production of this WFST is unrealistic, and therefore, in reality, all connections are not modeled. A language model WFST is learned from a large volume of sentences. For example, a connection between words having an appearance frequency degree equivalent to or smaller than a fixed value is removed from the model. In a case where a connection to a word not modeled appears during search, a token transits to a state called backoff. Transition to the backoff state is equivalent to consideration of a low-order connection. For example, a connection between four words of A, B, C, and D appears but is not modeled, a token transits to the backoff state, and a connection between three words of B, C, and D is considered (when even this connection is not modeled, the token transits to a next backoff state to consider a connection of two words of C and D).

An input label of each arc of the language model WFST is a word. At the time of transition of a token on the language model WFST, an arc having a word input from a current state (a word output from a small WFST in the case of on-the-fly synthesis) is traced. In a case where no arc having an input word is present, the toke transits to the backoff state, and an arc having the input word is similarly searched from this state. In other words, in the case of transition to the backoff state, transition through a plurality of arcs is caused in response to a single input.

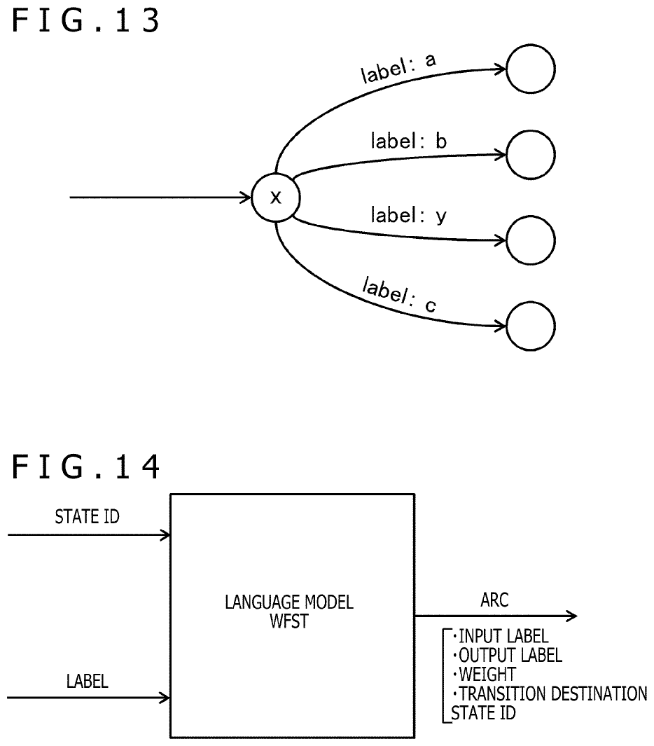

FIG. 13 depicts a situation where an arc extends from a state “x” for each input label. According to the example depicted in the figure, arcs corresponding to words “a,” “b,” “c,” and “y,” which are input labels, extend from the state “x.” For example, when the word “y” is input in the state “x,” the arc corresponding to the input label “y” is searched.

FIG. 14 depicts a relation between input and output of the language model WFST. The input of the language model WFST is constituted by a state ID and a label, while the output of the language model WFST is an arc. The arc is constituted by information containing an input label, an output label, and a weight, and further a state ID of a transition destination added to these.

The technology according to the present disclosure divides a huge-sized WFST into two parts, and arranges these parts separately in two storage areas to achieve WFTS search in a memory-saving manner and at high speed. Described hereinafter will be a first embodiment which achieves on-the-fly synthesis using a many-core arithmetic unit such as a GPU, and a second embodiment which achieves on-the-fly synthesis using WFST data divided into two parts separately arranged in a memory and a disk. Further described will be a third embodiment which is a specific example to which a large-scale graph search technology according to the present disclosure is applied.

### First Embodiment

### F. Speech Recognition Process in Hybrid Environment

A many-core arithmetic unit such as a GPU is used in some cases to increase a speed of a WFST model search process (described above). However, a typical many-core arithmetic unit such as a GPU has only a limited memory capacity. A main memory accessible from a CPU (Central Processing unit) is relatively easily expandable to several hundreds of GB (gigabytes). On the other hand, a memory mounted on a GPU has a capacity in a range approximately from several GB to ten-odd GB at most. It is difficult to perform a search process of a large-vocabulary speech recognition based on a WFST model having a size of several tens of GB or more by using a many-core arithmetic unit such as a GPU due to running out of a device memory.

For example, there has been proposed a data processing method which performs WFST search based on on-the-fly synthesis (described above) in a hybrid environment using both a CPU and a GPU (see PTL 1). According to this data processing method, a WFST model is divided into two WFST models constituted by a large part and a small part. An arithmetic operation using the small WFST model is performed by the GPU, while an arithmetic operation using the large WFST model is performed by the CPU. In this case, the small WFST model is decompressed in a memory of the GPU, while the large WFST model consuming a large memory volume is arranged in a main memory. This arrangement solves the problem of running short of the device memory. According to this data processing method, state transition of the small WFST model is achieved by the GPU, while correction of the likelihood using the large WFST model is achieved by the CPU.

The likelihood correction using the large WFST model in the latter case herein performs a process for acquiring a particular arc extending from a certain state (model lookup). Following TABLE 1 presents a data structure of the large WFST model by way of example. At the time of input of State (state ID) and Label (word ID), a position of Arc (arc) corresponding to this input is searched and referred to in the process using the large WFST model (see FIG. 13). In addition, there is also a case where a corresponding arc is absent. In this case, transition to a state called backoff is caused, and a corresponding arc is again searched from this backoff state. For searching a position of an arc, binary search or hashmap is adopted, for example.

TABLE 1

| State | Label | Arc |
|---|---|---|
| 1 | 0 | arc[0] |
| | 1 | arc[1] |
| | 3 | arc[2] |
| | 7 | arc[3] |
| 2 | 0 | arc[4] |
| | 2 | arc[5] |
| | 7 | arc[6] |
| | 9 | arc[7] |
| | 11 | arc[8] |
| 3 | 0 | arc[9] |
| | 8 | arc[10] |

However, an arithmetic operation using the large WFST model requires a large calculation volume. Accordingly, if the likelihood correction using the large WFST model is executed by the CPU while executing the state transition of the small WFST model by the GPU, there is a possibility that performance (processing speed or throughput) does not sufficiently improve due to a bottleneck produced by the arithmetic operation on the CPU side even after introduction of the GPU.

The process using the large WFST model (e.g., binary search or lookup of hashtable) requires a relatively large arithmetic operation volume. Accordingly, in a case of an architecture where calculation performance of a CPU is extremely lower than that of a GPU, for example, the process on the CPU side does not catch up with the GPU even in a situation of a sufficient calculation resource on the GPU side performing the arithmetic operation using the small WFST model. In this case, performance of the speech recognition process may reach a limit.

The present applicant considers that a system capable of using up respective calculation resources of the CPU and the GPU without deficiency and excess needs to be prepared so as to achieve maximum performance in the hybrid environment using both the CPU and the GPU. This type of system is difficult to be prepared particularly in a cloud environment where each configuration of the CPU and the GPU is limited to a particular configuration.

Accordingly, proposed hereinafter in the first embodiment will be a technology for performing WFST search based on on-the-fly synthesis in a hybrid environment while reducing an arithmetic operation volume on the CPU side as much as possible and more effectively utilizing a calculation resource of a GPU in any system.

The first embodiment is achieved by executing a large-scale graph search process for speech recognition using a GPU in a hybrid environment using both a CPU and the GPU. The large-scale graph referred to herein specifically corresponds to a large language model which is a larger one of two divided parts of a language model, i.e., a language model WFST. In addition, the large scale refers to a size difficult to decompress in a device memory, such as several tens of GB or more.

However, the application range of the technology according to the present disclosure is not limited to the GPU and the graph search process for speech recognition. It should be fully understood that the GPU is replaceable with a many-core arithmetic unit having a limited memory capacity (having a memory capacity smaller than a graph size), and that the graph search process for speech recognition is replaceable with a general graph search process.

### F-1. System Configuration

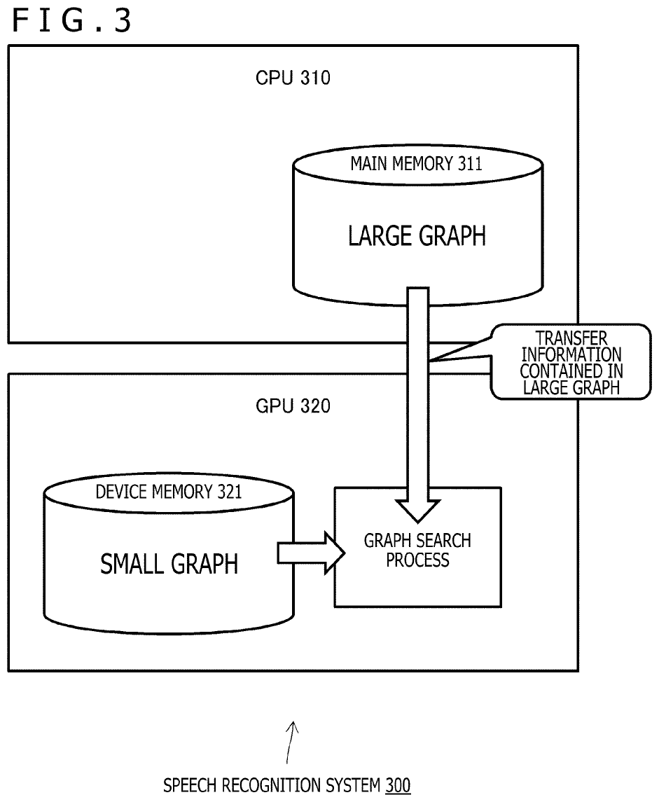

FIG. 3 schematically depicts a configuration example of a speech recognition system 300 to which the technology proposed in the first embodiment is applied. The speech recognition system 300 depicted in the figure has a hybrid environment using a CPU 310 and a GPU 320.

The CPU 310 includes a main memory 311 having a relatively large capacity (e.g., approximately several tens of GB) as a local memory. On the other hand, the GPU 320 is constituted by a many-core arithmetic unit, and capable of executing WFST or other graph search processes at high speed by performing parallel processing or the like using respective cores. The GPU 320 also includes a local memory (herein referred to “device memory”) 321, but has a smaller capacity, such as approximately several GB, than that of the main memory.

However, the GPU 320 is also allowed to access the main memory 311. Data is copied from the main memory 311 to the device memory 321 using the CPU 310. Alternatively, the GPU 320 may access the main memory 311 at high speed using a DMA (direct memory access) function.

The speech recognition system 300 performs on-the-fly synthesis which divides a WFST model into two parts constituted by a large part and a small part, and synthesizes these parts at the time of execution of speech recognition. Initially, a large-sized language model is divided into two parts constituted by a large part and a small part. Subsequently, the small language model considering a connection between two words is synthesized with an acoustic model and a pronunciation dictionary to produce a small WFST model. The small WFST model (small graph) is arranged in the device memory 321 having a relatively small capacity. In addition, a language model considering a connection of four words constitutes a large WFST model. The large WFST model (large graph) has a size of approximately several tens of GB and is arranged in the main memory 311.

According to the data processing method disclosed in PTL 1, state transition of the small WFST model is achieved by the GPU, while correction of a likelihood using the large WFST model is achieved by the CPU (described above). On the other hand, according to the speech recognition system of the present embodiment, a WFST model search process is not performed by the CPU 310 but basically executed only by the GPU 320.

The GPU 320 basically causes transition of a token on the small WFST model. When state transition on the large WFST model is needed in response to output of a word from an arc to which the token has transited, a search process is performed not by the CPU 310 but by the GPU 320. In this case, the GPU 320 performs the entire search process while copying only a data part necessary for processing in the large WFST model (specifically, the input label, the output label, and the weight of the arc, and the state ID of the destination of the arc transition) from the main memory 311 to the device memory 321. As a result, the CPU 310 is basically required to perform only processing of data transfer to the GPU 320 and control of the GPU 320. Accordingly, efficient utilization of the calculation resource of the GPU 320, and considerable reduction of a load imposed on the CPU 310 side are both achievable.

Listed herein are advantages to be produced by execution of the WFST search process using the GPU 320.

### (Advantage 1) Processability at Higher Speed:

A plurality of hypotheses (tokens) can be processed in parallel by using an arithmetic unit having a large number of cores, such as GPU. Accordingly, a processing time required for search can be reduced. Particularly in a case of a speech recognition service such as a speech agent, high-speed processing is essential to give a quick response to a user.

### (Advantage 2) Processability of Many Processes at Lower Cost:

Efficient use of the GPU allows handling of more processes at lower cost than use of only a CPU (e.g., in a case of a virtual server in a cloud, a price of the GPU per calculation ability ($/Flops (Floating-point Operations Per Second)) is lower). This ability of handling more processes allows simultaneous processing of many requests using a small number of servers (i.e., at low cost) when a speech recognition service is provided.

### (Advantage 3) Adjustability of Processing Balance Between CPU and GPU:

For DNN calculation in a stage before WFST search, a GPU is often employed to perform high-speed processing. However, when a CPU is used to perform WFST search, a calculation resource of the GPU is difficult to use up due to a bottleneck produced by the CPU, and is wasted in some cases. According to the present embodiment, however, processing volumes of the CPU and the GPU are adjustable by using the GPU to execute WFST search, and therefore calculation resources of both the CPU and the GPU can be used up. Moreover, a larger number of speech recognition requests are processible by using one device (e.g., server).

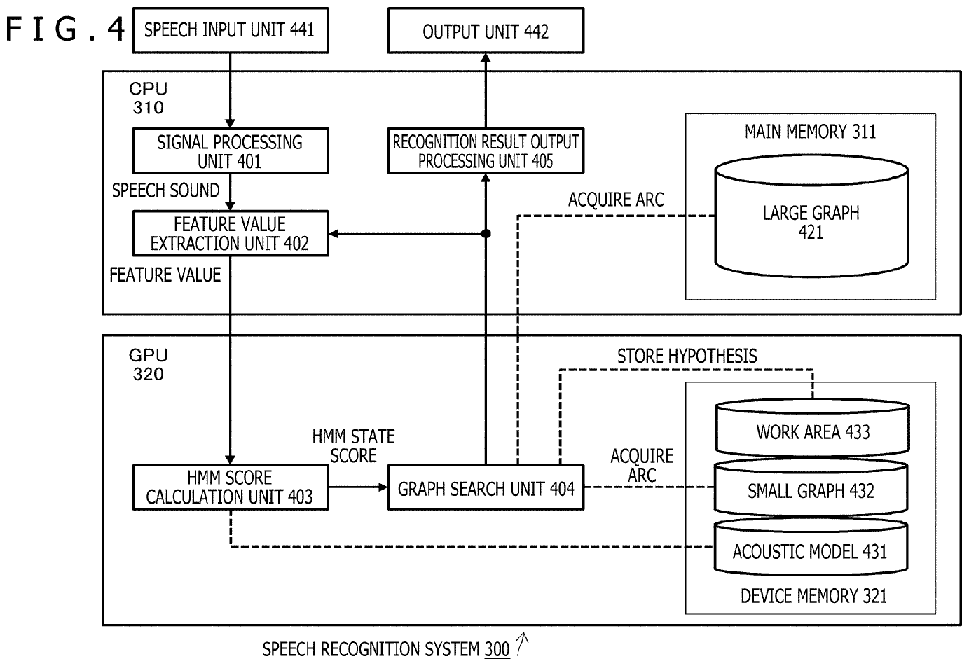

FIG. 4 depicts a more specific functional configuration example of the speech recognition system 300. As already described above with reference to FIG. 3, the speech recognition system 300 has a hybrid environment using the CPU 310 and the GPU 320. The CPU 310 includes the main memory 311 having a relatively large capacity (e.g., approximately several tens of GB) as a local memory. On the other hand, the GPU 320 includes the device memory 321 having a small capacity.

A signal processing unit 401, a feature value extraction unit 402, and a recognition result output processing unit 405 are disposed within the CPU 310. On the other hand, an HMM score calculation unit 403 and a graph search unit 404 are disposed on the GPU 302. In reality, these function modules indicated by reference numbers 401 to 405 may be software programs executed by the CPU 310 or the GPU 320.

A speech input unit 441 is constituted by a microphone or the like, and collects speech signals. The signal processing unit 401 performs predetermined digital processing for the speech signals received by the speech input unit 441.

Subsequently, the feature value extraction unit 402 extracts feature values of speech sound using a known technology such as Fourier transform and mel filter bank. While the feature value extraction unit 402 is disposed on the CPU 310 side in the system configuration example depicted in FIG. 4, the feature value extraction unit 402 may be implemented by the GPU 320.

The HMM score calculation unit 403 receives information associated with the feature values of the speech sound, and calculates scores of respective HMM states using an acoustic model 431. A Gaussian Mixture Model (GMM) or a DNN is used for an HMM.

In a case where the GPU 320 performs HMM score calculation using the HMM score calculation unit 403 disposed on the GPU 320, the acoustic model 431 is arranged within the GPU memory (device memory) 321 as depicted in FIG. 4. However, the processing of HMM score calculation may be performed on the CPU 310 side. In this case, the acoustic model 431 is arranged in the main memory 321.

The graph search unit 404 receives the HMM state scores, and performs a search process based on on-the-fly synthesis using a small graph (small WFST model) 432 in the GPU memory (device memory) 321, and a large graph (large WFST model) 421 in the main memory 311.

Intermediate recording such as a hypothesis list of recognition results generated by the search process using the graph search unit 404 is temporarily stored in a work area 433 in the device memory 321. Incidentally, while not depicted in FIG. 4, the intermediate recording described above may be stored in a work area in the main memory 311, or may be stored in both the device memory 321 and the main memory 311.

The graph search unit 404 finally outputs a character string of a speech recognition result. This character string of the recognition result is sent from the work area 433 in the device memory 321 to the recognition result output processing unit 405 on the CPU 310 side. The recognition result output processing unit 405 performs processing for displaying or outputting the recognition result using an output unit 442 constituted by a display, a speaker, or the like.

Note that the speech recognition system 300 may be configured to function as a device including at least either the speech input unit 441 or the output unit 442. Alternatively, the CPU 310 and the GPU 320 may be equipped within a server in a cloud, while the speech input unit 441 and the output unit 442 may be configured to function as a speech agent device (described below).

### F-2. System Operation

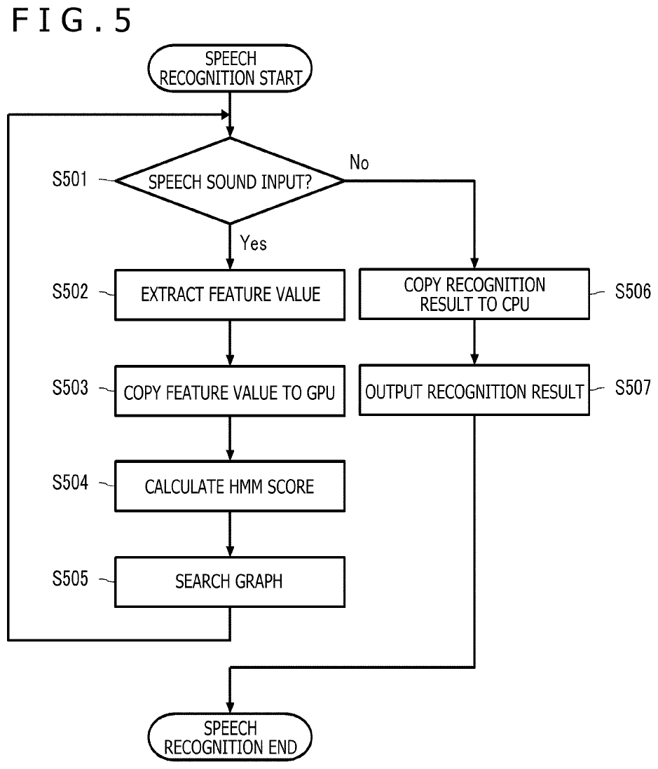

FIG. 5 presents a general processing procedure for speech recognition in a form of a flowchart, executed by the speech recognition system 300 depicted in FIG. 4.

When speech sound is input to the speech input unit 441 (Yes in step S501), speech data obtained after digital processing by the signal processing unit 401 is separated every ten milliseconds, for example, and input to the feature value extraction unit 402.

The feature value extraction unit 402 extracts feature values of the speech sound using a known technology such as Fourier transform and mel filter bank on the basis of speech data obtained after digital processing by the signal processing unit 401 (step S502). In a case where HMM score calculation is performed using the GPU 320 as depicted in FIG. 4, feature value data is copied to the device memory 321 on the GPU 320, and input to the HMM score calculation unit 403 (step S503).

Subsequently, the HMM score calculation unit 403 receives information associated with the feature values of the speech sound, and calculates scores of respective HMM states using the acoustic model 431 (step S504).

Thereafter, the graph search unit 404 receives the HMM state scores, and performs a search process based on on-the-fly synthesis using a small graph (small WFST model) 432 in the GPU memory (device memory) 321, and a large graph (large WFST model) 421 in the main memory 311 (step S505).

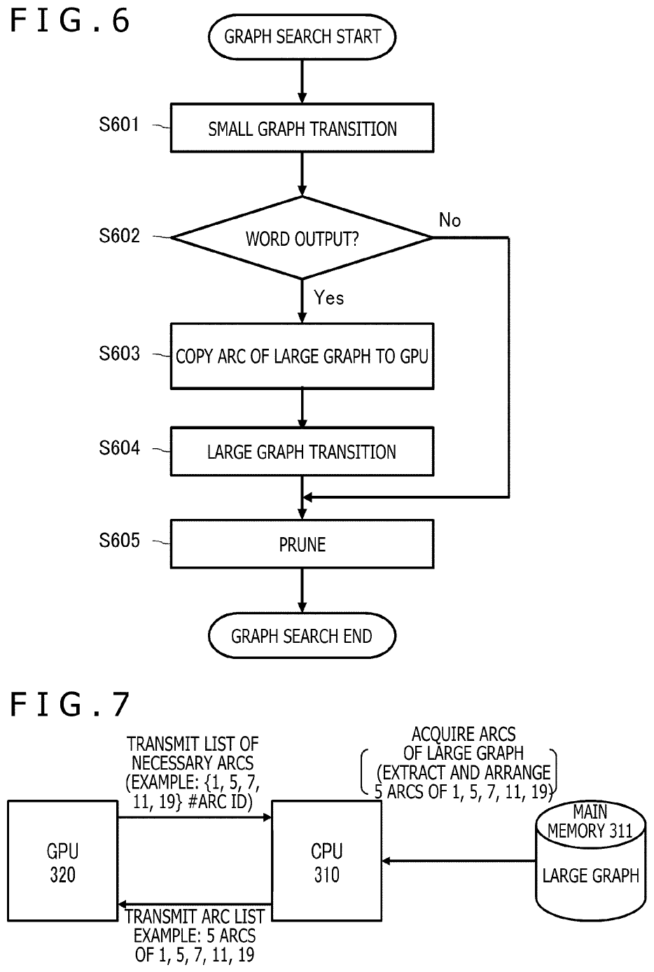

In step S505, the graph search unit 404 initially causes transition of a token on the small graph. In a case where a word is output from the small graph as a result of this transition, information associated with an arc of the large graph is copied to the device memory 321 of the GPU 320 to cause transition of a token on the large graph. Then, after transition of all hypotheses, the graph search unit 404 prunes the entire hypotheses. However, details of this processing will be described below (refer to FIG. 6).

Until arrival at a final end of the input speech (Yes in step S501), processing from steps S502 to S505 described above is repeatedly executed for the speech data separate every ten milliseconds, for example.

In addition, after arrival at the final end of the input speech sound (No in step S501), the character string of the speech recognition result obtained by the graph search unit 404 is copied from the work area 433 in the device memory 321 to the main memory 311 on the CPU 310 side (step S506).

Thereafter, the recognition result output processing unit 405 performs processing for displaying or outputting the recognition result using the output unit 442 constituted by a display, a speaker, or the like (step S507).

FIG. 6 presents a detailed processing procedure of the graph search process in a form of a flowchart, executed in step S505 in the flowchart presented in FIG. 5.

The graph search unit 404 causes transition of a token on the small graph 432 (small WFST model) in the device memory 321 (step S601).

In a case where a word is output from the arc to which the token has transited herein (Yes in step S602), state transition of a token is caused on the large graph (large WFST model). Specifically, the graph search unit 404 calculates an address at which necessary information associated with the arc of the large graph is stored in the main memory 321, and copies the information associated with the arc of the large graph from the corresponding address in the main memory 321 to the device memory 321 on the GPU 320 side (step S603), and causes transition of the token on the large graph in the device memory 321 (step S604). Then, after transition of all hypotheses, the graph search unit 404 prunes the entire hypotheses (step S605), and ends the present process. In addition, in a case where no word is output from the arc to which the token has transited (No in step S602), the graph search unit 404 similarly prunes the entire hypotheses (step S605), and ends the present process.

### F-3. Linkage Between Graphs

As apparent from the flowchart presented in FIG. 6, information associated with an arc of the large graph is required when a word is output from an arc of the small graph during transition of a token (by the graph search unit 404) by the GPU 320 using the small graph in the device memory 321.

Accordingly, the GPU 320 may calculate a position where the necessary arc of the large graph is located in the main memory 311 (address information) beforehand. This calculation can eliminate the necessity of performing a large graph search process requiring a large arithmetic operation volume using the CPU 310, such as binary search and lookup of hashtable, at the time of a request for a necessary arc of the large graph from the GPU 320, and therefore reduce a load imposed on the CPI 310.

Examples of the method which copies the arc of the large graph from the main memory 311 to the device memory 320 include a method which provides a single virtual memory space used by both the CPU 310 and the GPU 320, and a method which sends information associated with a necessary arc from the GPU 320 to the CPU 310, and copies the information from the main memory 311 to the device memory 321 on the CPU 310 side.

According to the former method which uses the single virtual memory space, the CPU 310 and the GPU 320 have a common page table. At the time of reference to an access to a page absent in the device memory 321 on the GPU 320 side, this page is shifted from the main memory 311 to the device memory 321. For example, shift of this page can be achieved from the main memory 311 to the device memory 321 by a driver of the GPU 320 using a CUDA (registered trademark) (Compute Unified Device Architecture) Unified Memory function which is a general-purpose parallel computing platform provided by U.S. NVIDIA Corporation.

On the other hand, according to the latter method which sends information associated with a necessary arc from the GPU 320 to the CPU 310 and copies the information to the device memory 321 on the CPU 310 side, in a case where information associated with necessary arcs and calculated on the GPU 320 side beforehand is sent from the GPU 320 to the CPU 310, a list of position information associated with the necessary arcs calculated on the GPU 320 side (e.g., indices of an arc array in the main memory 311 or arc addresses) is sent to the CPU 310. Thereafter, the CPU 310 side copies the necessary arcs to the device memory 321 on the basis of the received list.

FIG. 7 is an illustration of the latter method. Initially, the GPU 320 sends a list of necessary arcs to the CPU 310 side. According to the example depicted in the figure, the GPU 310 transmits a list of arcs {1, 5, 7, 11, 19} and arc IDs to the CPU 310. Thereafter, the CPU 310 extracts and arranges the five arcs {1, 5, 7, 11, 19} from the large graph stored in the main memory 311 on the basis of the received list, returns the arcs to the GPU 320 side, and copies the arcs to the device memory 321.

### F-4. Modifications

### F-4-1. Modification of GPU Memory Including Cache for Arcs of Large Graph

Communication between the CPU 310 and the GPU 320 generally requires more latency than that of an ordinary memory access. Accordingly, arcs of the large graph are stored (or cached) in the device memory 321 on the GPU 320 side to improve a processing speed. Reference to the same data often continues within the large graph due to characteristics of graph search in speech recognition. Accordingly, the present applicant considers that this method is effective.

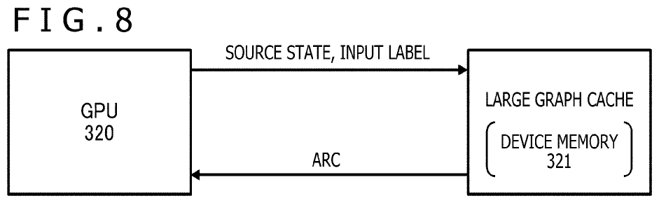

FIG. 8 illustrates a caching mechanism for caching an arc of the large graph in the device memory 321 on the GPU 320 side. According to the example depicted in the figure, a data structure which receives input constituted by an ID of a source state (state before transition) and an input label and returns an arc is provided as a cache in the device memory 321.

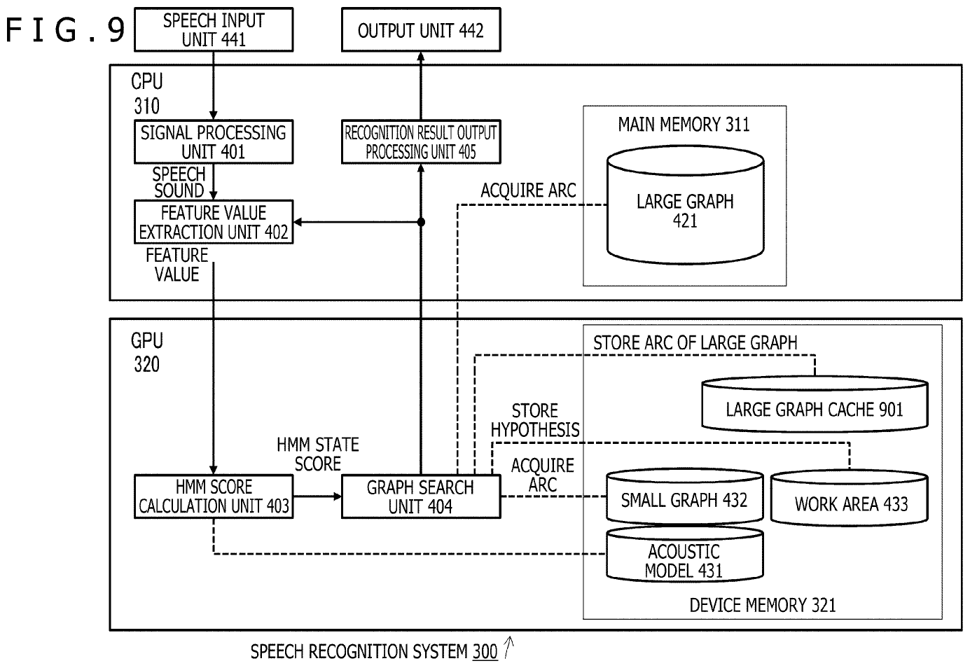

FIG. 9 depicts a configuration example of the speech recognition system 300 including a cache for the large graph.

The signal processing unit 401, the feature value extraction unit 402, and the recognition result output processing unit 405 are disposed within the CPU 310. On the other hand, the HMM score calculation unit 403 and the graph search unit 404 are disposed on the GPU 302. In reality, these function modules indicated by reference numbers 401 to 405 may be software programs executed by the CPU 310 or the GPU 320.

The speech input unit 441 is constituted by a microphone or the like, and collects speech signals. The signal processing unit 401 performs predetermined digital processing for the speech signals received by the speech input unit 441. The feature value extraction unit 402 extracts feature values of speech sound using a known technology such as Fourier transform and mel filter bank.

The HMM score calculation unit 403 receives information associated with the feature values of the speech sound, and calculates scores of respective HMM states using the acoustic model 431 in the GPU memory (device memory) 321. A GMM or a DNN is used for an HMM.

The graph search unit 404 receives the HMM state scores, and performs a search process based on on-the-fly synthesis using the small graph (small WFST model) 432 in the GPU memory (device memory) 321, a large graph cache 901, and the large graph (large WFST model) 421 in the main memory 311.

Initially, the graph search unit 404 causes transition of a token on the small graph. In a case where a word is output from the small graph by this transition, the graph search unit 404 receives an input constituted by an ID of a source state (state before transition) and an input label, and acquires information associated with an arc of the large graph from the large graph cache 901, and then causes transition of a token on the large graph. Moreover, in a case where a cache miss is produced in the large graph cache 901, the graph search unit 404 copies information associated with arcs of the large graph to the device memory 321 of the GPU 320, caches the corresponding information associated with the arcs of the large graph within the large graph cache 901, and then causes transition of a token on the large graph.

Intermediate recording such as a hypothesis list of recognition results generated by a search process using the graph search unit 404 is temporarily stored in a work area 433 in the device memory 321. Then, after transition of all hypotheses, the graph search unit 404 prunes the entire hypotheses.

The graph search unit 404 finally outputs a character string of a speech recognition result. This character string of the recognition result is sent from the work area 433 in the device memory 321 to the recognition result output processing unit 405 on the CPU 310 side. The recognition result output processing unit 405 performs processing for displaying or outputting the recognition result using the output unit 442 constituted by a display, a speaker, or the like.

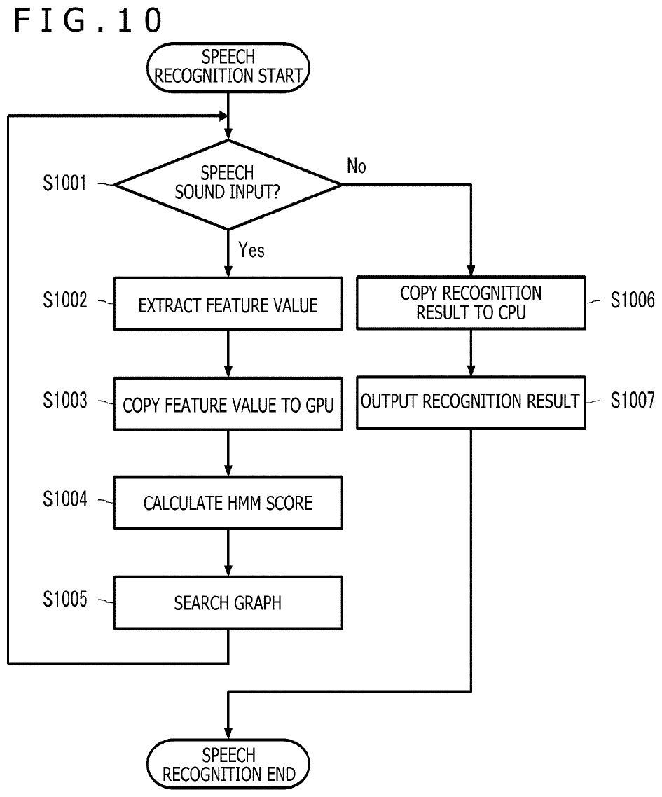

FIG. 10 presents a general processing procedure for speech recognition in a form of a flowchart, executed by the speech recognition system 300 depicted in FIG. 9.

When speech sound is input to the speech input unit 441 (Yes in step S1001), speech data obtained after digital processing by the signal processing unit 401 is separated every ten milliseconds, for example, and input to the feature value extraction unit 402.

The feature value extraction unit 402 extracts feature values of the speech sound using a known technology such as Fourier transform and mel filter bank on the basis of speech data obtained after digital processing by the signal processing unit 401 (step S1002). In a case where HMM score calculation is performed using the GPU 320 as depicted in FIG. 9, feature value data is copied to the device memory 321 on the GPU 320, and input to the HMM score calculation unit 403 (step S1003).

Subsequently, the HMM score calculation unit 403 receives information associated with the feature values of the speech sound, and calculates scores of respective HMM states using the acoustic model 431 (step S1004).

Subsequently, the graph search unit 404 receives the HMM state scores and performs a search process based on on-the-fly synthesis using the small graph (small WFST model) 432 in the GPU memory (device memory) 321, the large graph cache 901, and the large graph (large WFST model) 421 in the main memory 311 (step S1005).

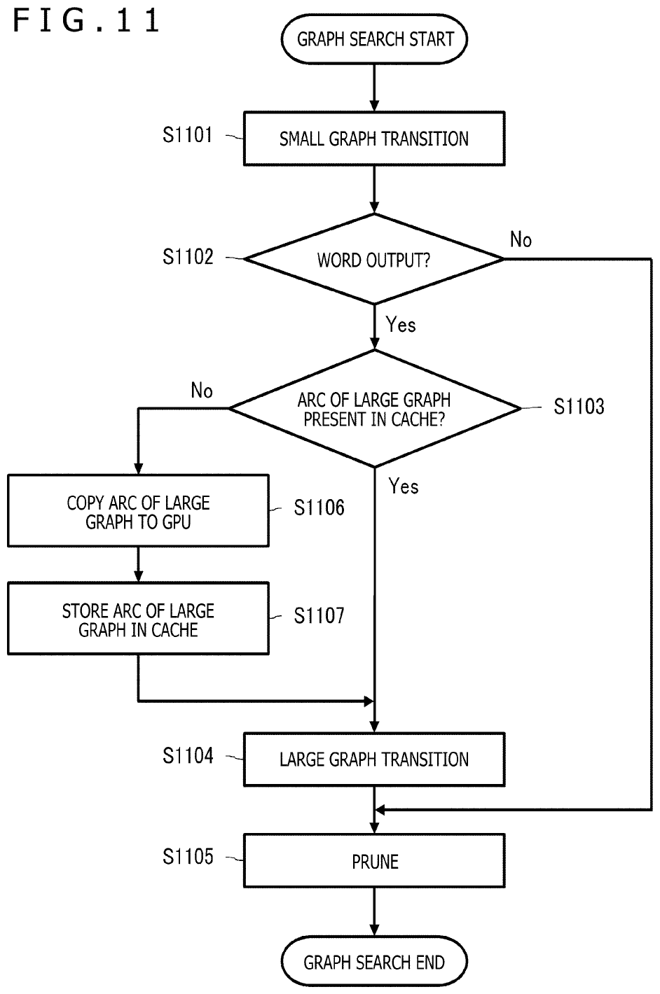

In step S1005, the graph search unit 404 initially causes transition of a token on the small graph. In a case where a word is output from the small graph by this transition, the graph search unit 404 receives input constituted by an ID of a source state (state before transition) and an input label, and acquires information associated with arcs of the large graph from the large graph cache 901, and then causes transition of a token on the large graph. Moreover, in a case where a cache miss is produced in the large graph cache 901, the graph search unit 404 searches the large graph (large WFST model) 421 in the main memory 311, and acquires a target arc. Then, after transition of all hypotheses, the graph search unit 404 prunes the entire hypotheses. However, details of the graph search process will be described below (see FIG. 11).

Until arrival at a final end of the input speech (Yes in step S1001), processing from steps S1002 to S1005 described above is repeatedly executed for the speech data separated every ten milliseconds, for example.

In addition, after arrival at the final end of the input speech sound (No in step S1001), the character string of the speech recognition result obtained by the graph search unit 404 is copied from the work area 433 in the device memory 321 to the main memory 311 on the CPU 310 side (step S1006).

Thereafter, the recognition result output processing unit 405 performs processing for displaying or outputting the recognition result using the output unit 442 constituted by a display, a speaker, or the like (step S1007).

FIG. 11 presents a detailed processing procedure of the graph search process in a form of a flowchart, executed in step S1005 in the flowchart presented in FIG. 10.

The graph search unit 404 causes transition of a token on the small graph 432 (small WFST model) in the device memory 321 (step S1101).

In a case where a word is output from the arc to which the token has transited herein (Yes in step S1102), the graph search unit 404 receives input constituted by an ID of a source state (state before transition) and an input label, and checks whether or not desired information associated with the arc of the large graph is present within the large graph cache 901 (step S1103).

Thereafter, in a case where the desired information associated with the arc of the large graph is present within the large graph cache 901, i.e., in a case of a cache hit (Yes in step S1103), the graph search unit 404 acquires the information associated with the arc of the large graph from the large graph cache 901, and causes state transition of a token on the large graph (large WFST model) (step S1104).

Moreover, in a case where the large graph cache 901 produces a cache miss (No in step S1103), the graph search unit 404 calculates an address storing necessary information associated with the arc of the large graph in the main memory 321, and copies the information associated with the arc of the large graph from the address in the main memory 321 to the small graph 432 within the device memory 321 on the GPU 320 side (step S1106), and caches the information associated with the arc of the large graph within the large graph cache 901 (step S1107), and then causes transition of a token of the large graph in the device memory 321 (step S1104).

Then, after transition of all hypotheses, the graph search unit 404 prunes the entire hypotheses (step S1105), and ends the present process.

### F-4-2. Modification of Large Graph Decompressed not in Main Memory

Also considered is a method which decompresses the large graph in a place other than the main memory 311, and performs a graph search process in a manner similar to the manner described above. For example, the large graph may be decompressed in an external storage device such as an SSD, a memory of another system provided via a network, a memory of another device disposed with the same system 300, or the like.

### F-5. Summary

Advantageous effects offered by the technology according to the first embodiment will be touched upon herein.

The speech recognition system to which the technology according to the first embodiment is applied is capable of executing a large-scale graph search process at high speed by using a many-core arithmetic unit having a limited memory capacity.

The speech recognition system to which the technology according to the first embodiment is applied is capable of executing a large-scale graph search process using on-the-fly synthesis in a hybrid environment including a CPU and a GPU (or other types of many-core arithmetic units) without imposing an excessive load on the CPU. In this case, following advantages are offered.

(a) Processability at higher speed.

(b) Processability of many processes at lower cost.

(c) Adjustability of processing balance between CPU and GPU.

The technology described in the first embodiment is applicable to various cases each applying a graph search process permitting on-the-fly synthesis to a hybrid environment.

### Second Embodiment

### G. Speech Recognition Process Arranging WFST Data in Disk

A WFST handling a large vocabulary has a size ranging approximately from several tens of GB to several hundreds of GB, and a system having a large memory capacity is therefore required to perform WFTS search. Accordingly, a method which arranges all WFST data in a disk and performs a search process has been proposed (e.g., see NPL 4). Specifically, a WFST is divided into three files constituted by a nodes-file describing positions of arcs extending from respective states (nodes), an arcs-file describing information associated with arcs, and a word strings-file describing words corresponding to output symbols, and these files are separately arranged in a disk. According to this configuration, information associated with any arc is acquirable by two disk accesses. Moreover, the number accesses to the disk can be reduced by retaining (i.e., caching) arcs once read from the disk for a while. In this manner, an increase in the processing time required for disk accessing can be reduced.

Further proposed has been a method which arranges all WFST data in the disk, and arranges offset data of the WFST data in a memory to acquire any arc by one disk access (e.g., see NPL 5). Specifically, the offset data of the WFST data corresponds to the “nodes-file” which is information indicating positions of arcs extending from respective nodes as described above. This method reduces the number of disk accesses and therefore achieves high-speed processing. However, this method requires a large memory use volume.

Accordingly, proposed hereinafter in the second embodiment will be a technology which achieves real-time processing while reducing an increase in a processing time produced by arranging all WFST data in a disk. Note that the “real-time processing” herein refers to processing one-second speech sound within one second, for example. For using speech recognition in an actual service such as a speech agent, it is essential to give a real-time response to a user.

The processing time increases as a result of a bottle neck produced by IOPS of a disk (the number of I/O accesses processible by the disk per one second). As data arranged in a memory (e.g., caches) increases, higher-speed processing is achievable by reduction of the number of accesses to the disk. However, reduction of the memory use volume is difficult to achieve. According to the second embodiment, a high-speed speech recognition process is achievable while reducing a memory use volume by contriving data arranged in the memory (i.e., carefully selecting only useful data and arranging the data in the memory).

### G-1. System Configuration

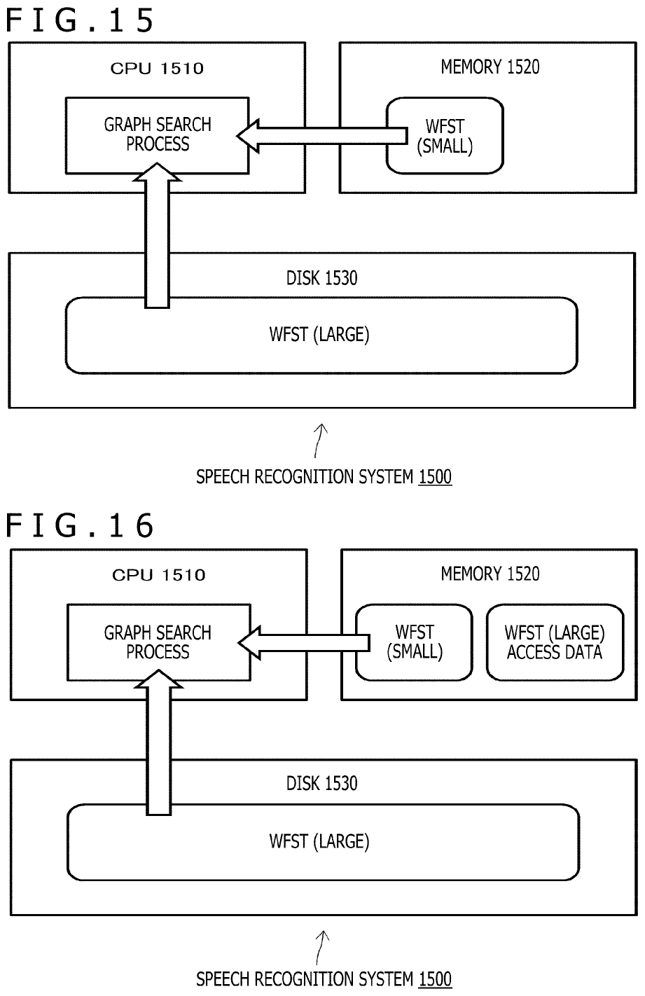

FIG. 15 schematically depicts a configuration of a speech recognition system 1500 to which the technology proposed in the second embodiment is applied. The speech recognition system 1500 depicted in the figure includes a CPU 1510, a main storage device (hereinafter referred to as “memory”) 1520, and an auxiliary storage device (hereinafter referred to as “disk”) 1530.

The speech recognition system 1500 performs on-the-fly synthesis which divides a WFST model into two parts constituted by a large part and a small part, and synthesizes these parts at the time of execution of speech recognition. Initially, a large-sized language model is divided into two parts constituted by a large part and a small part. Subsequently, the small language model considering a connection between two words is synthesized with an acoustic model and a pronunciation dictionary to produce a small WFST model. The small WFST model (small graph) is arranged in the memory 1520 having a relatively small capacity. In addition, a language model considering a connection of four words constitutes a large WFST model. The large WFST model (large graph) is arranged in the disk 1530.

The CPU 1510 causes state transition of the small WFST model in the memory 1520, and performs likelihood correction using the large WFST model in the disk 1530. The CPU 1510 basically causes transition of a token on the small WFST model arranged in the memory 1520. When state transition of the large WFST model is needed by output of a word from an arc to which the token has transited, the CPU 1510 accesses the disk 1520, and performs an entire search process while copying only a data part necessary for processing in the large WFST model (specifically, the input label, the output label, and the weight of the arc, and a state ID of arc transition destination) to the memory 1520.

An access frequency to WFST data (arcs) used in speech recognition is considerably biased. In the case of the WFST model division method for on-the-fly synthesis, a large language model WFST is accessed only when a word is output from a small WFST. Accordingly, the access frequency of the large language model WFST is low. In the case of on-the-fly synthesis, therefore, a portion occupying the most part of WFST data and less frequently accessed can be separated as the large language model WFST. Accordingly, the small WFST model more frequently accessed is arranged in the memory 1520 capable of achieving high-speed processing, while the language model WFST less frequently accessed and large-sized is arranged in the disk 1530. In this manner, high-speed WFST search is achievable while reducing the memory use volume by reduction of the frequency of access to the disk 1530.

### G-2. Method for Reducing Number of Disk Accesses (1)

Higher-speed processing is achievable by arranging data in the memory 1520 as data for reducing the number of accesses to the language model WFST arranged in the disk 1530 (hereinafter also referred to as WFST (large) access data”).

As depicted in FIG. 14, search for the language model WFST is a process for extracting a corresponding arc on the basis of a state ID of a source state and a label (input label). When all data of language model WFST is arranged in the disk 1530, multiple disk accesses are performed to search a corresponding arc. Accordingly, “WFST (large) access data” for searching a corresponding arc is arranged in the memory 1520 to acquire the arc by one disk access (see FIG. 16).

It is assumed herein that data of respective arcs of a language model are arranged in the disk 1530 in an array. The data of each arc is assumed to include an input label, an output label, a weight, and a state ID corresponding to a transition destination of the arc. The array of the arcs arranged in the disk 1530 is also hereinafter referred to as an “arc array.” Moreover, the arcs are arranged in the disk 1530 in an order of the state ID of the source state, such as an order of an arc of a state 0, an arc of a state 1, an arc of a state 2, and others. In addition, there are a plurality of arcs extending from each of the states. The arcs having the same source state is sorted on the basis of a label (input label). For example, the arcs are arranged in the arc array of the disk 1530 in both the order of the state ID of the source state and an order of a label (input label) of an arc having the same source state, such as an arc of a source state 0 and a label 0, an arc of the source state 0 and a label 3, an arc of the source state 0 and a label 5, an arc of a source state 1 and the label 0, and others. Binary search is achievable by sorting arcs in the same state using input labels.

On the other hand, “Arc Indices” storing a start position (offset) of arcs in each of states in the arc array are arranged in the memory 1520 as WFST (large) access data. In the arc indices, start positions of arcs in the respective states in the arc array are sorted and arranged in the order of the state ID. For example, in a case where arcs extending from the state 5 starts at a tenth position in the arc array, a fifth element in the array of the arc indices is 10.

Moreover, an “input label array (Input Labels)” where labels (input labels) corresponding to the arcs in the arc array are arranged in a manner similar to the manner of the arc array is also arranged in the memory 1520 as WFST (large) access data. The arcs are sorted and arranged in the arc array in both the order of the state ID of the source state and the order of the label (input label) of the arc having the same source state. Accordingly, the input labels of the respective arcs in the input array are also arranged in an order identical to the order of the arcs arranged in the arc array. For example, in a case where the label of the tenth arc in the arc array is 3, the tenth element in the input label array is 3.

Accordingly, a position of an arc corresponding to any state ID and any input label in the disk 1530 is recognizable without the necessity of access to the disk 1530 by using the arc indices and the input label array arranged in the memory 1520 at the time of execution of WFTS search by the CPU 1510 in the disk 1530. Initially, a start position of a state ID of a source state of a target arc in the arc array is specified on the basis of the arc indices, and then an input label of the target arc is searched on the basis of an element at the same start position in the input label array. In this manner, a position in the arc array arranged in the disk 1530 can be reached. In other words, any arc is acquirable by one disk access.

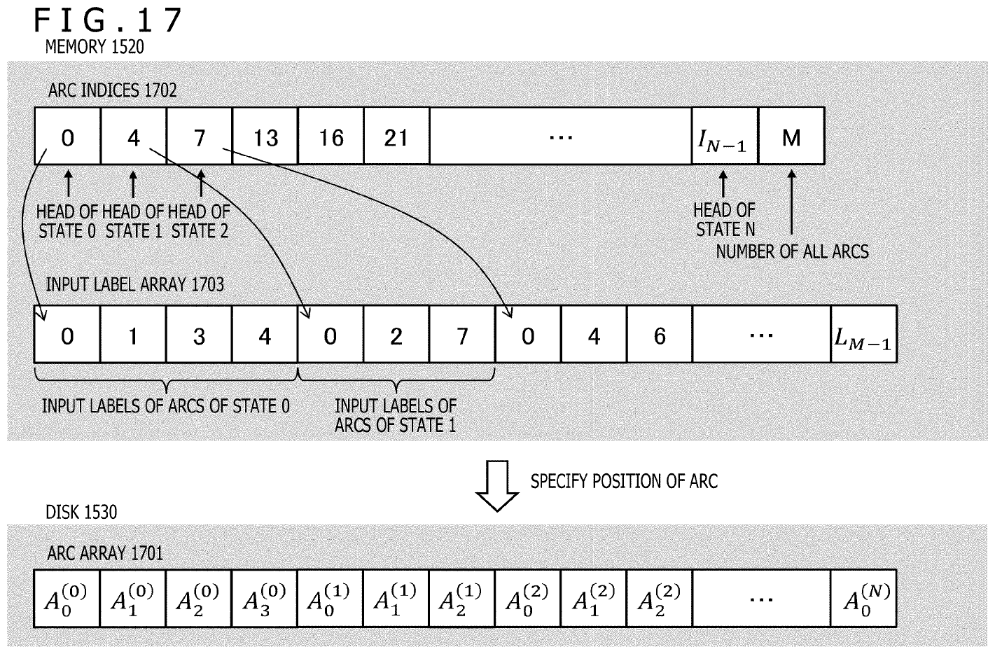

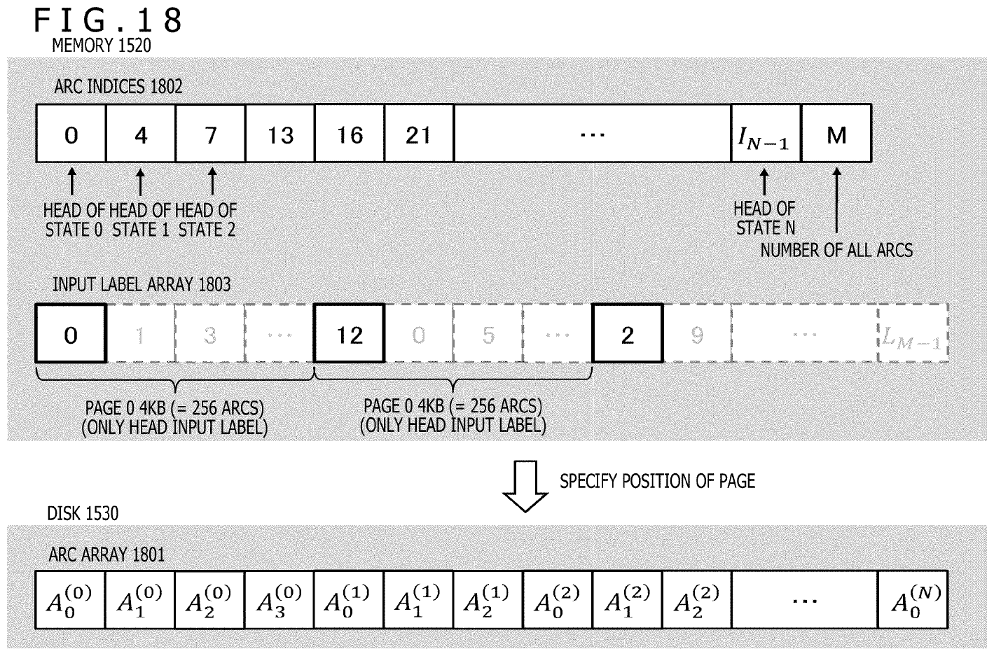

FIG. 17 depicts an arc array in the disk 1530, and arc indices and an input label array arranged in the memory 1520 as a specific example of WFST (large) access data.

An arc array 1701 in the disk 1530 is an array where arcs are sorted in both the order of the state ID of the source state and the order of the label (input label) of the arc having the same source state to arrange data of the respective arcs. The data of each arc is assumed to include an input label, an output label, a weight, and a state ID corresponding to a transition destination of the arc. An element expressed as “A⁽ⁱ⁾ⱼ” in the arc array 1701 herein represents an element storing data of an arc in a source state of a state ID “i” and having a jth input label. According to the example depicted in FIG. 17, an initial element to a fourth element store data in a source state of a state ID “0” and having input labels 0, 1, 3, and 4, respectively. Moreover, a fifth element to a seventh element store data in a source state of a state ID “1” and having input labels 0, 2, and 7, respectively. Binary search is achievable by sorting arcs in the same state using input labels.

On the other hand, arc indices 1702 arranged in the memory 1520 store a start position of arcs in each state in the arc array. The arc indices 1702 are constituted by array-type data sorted in accordance with the state ID. According to the example depicted in FIG. 17, states are sorted in an order of 0, 4, 7, 13, 16, 21, and others on the basis of the state ID. Each of the elements stores a start position of the corresponding state ID in the arc array 1701. For example, a first element of the arc indices 1702 stores 0 representing a start position of arcs in the state 0 in the arc array 1701, while a second element stores 4 representing a start position of arcs in the state 4 in the arc array 1701.

Moreover, the input label array 1703 arranged in the memory 1520 store labels (input labels) corresponding to the arcs in the arc array 1701 in an array identical to the array of the arc array 1701. Accordingly, respective elements of the input label array 1703 store input labels given to arcs of elements located at the same positions in the arc array 1701. According to the example depicted in FIG. 17, the initial element to the fourth element store input labels 0, 1, 3, and 4, respectively, extending from the source state having the state ID “0.” Moreover, the fifth element to the seventh element store input labels 0, 2, and 7, respectively, given to respective arcs extending from the source state having the state ID “1.”

At the time of search on a language model WFST arranged in the disk 1530 in the form of the arc array 1701, the CPU 1510 initially specifies a start position of a state ID of a source state of a target arc in the arc array with reference to the arc indices 1702 in the memory 1520. Thereafter, the CPU 1510 searches an input label of the target arc on the basis of an element at the same start position in the input label array 1703. In this manner, the CPU 1510 can reach the corresponding element in the arc array 1701 arranged in the disk 1530. In other words, any arc is acquirable by one disk access.

### G-3. Method for Reducing Number of Disk Accesses (2)

The method described in article G-2 described above causes such a problem that WFST (large) access data arranged in the memory 1520 is large-sized. Particularly, the input label array stores data of input labels corresponding to arcs of respective elements of the arc array, and therefore has a data size of approximately one fourth of the data size of the arc array arranged in the disk 1530. In this case, the object of reduction of the use volume of the memory 1520 may be difficult to achieve to a sufficient level.

For example, assuming that a WFST has one hundred million states and one billion arcs, data arranged in the disk 1530 has a size of 16 GB. On the other hand, data arranged in the memory 1530 has a size of 4.4 GB. Specifically, an arc is constituted by four data, i.e., an input label, an output label, a weight, and a state ID of a transition destination. Assuming that each data has a size of four bytes, one arc has a data size of 16 bytes. Accordingly, for one billion arcs, an arc array has a data size of 16 GB. In this case, an input label array arranged in the memory 1520 has a data size of 4 GB, while arc indices have a data size of 0.4 GB. The majority is therefore constituted by the input label array.

Accordingly, proposed in this article will be a method which further reduces a memory volume used by WFST (large) access data while increasing a WFST search speed by achieving acquisition of any arc by one disk access.

According to a typical operating system or file system, random access to a disk is performed in units of page size. One page has a size of 4 KB, while an arc has a data size of 16 bytes. Accordingly, latency for reading one arc is substantially equivalent to latency for reading 256 arcs (corresponding to one page).

According to the method proposed in this article, data is arranged to calculate a position of a page where a target arc is arranged. Subsequently, only the position of the page where the target arc is arranged is calculated, and disk access is executed to read one page, i.e., a memory having 4 KB. Thereafter, the target arc is searched from 256 arcs read into the memory. For specifying only the page where the target arc is arranged, it is sufficient if at least an initial input label of one page (256 arcs). In this manner, the input label array can be reduced to data having a data length of one 256th without increasing a processing time. Assuming that a WFST has one hundred million states and one billion arcs similarly to the above, the size of the input label array arranged in the memory can be reduced from 4 GB to 0.016 GB.

FIG. 18 depicts a specific example of WFST (large) access data for practicing the method proposed in this article. This method is similar to the example depicted in FIG. 17 in the point that an arc array is arranged in the disk 1530, and that arc indices and an input label array are arranged in the memory 1520.

Similarly to the example depicted in FIG. 17, an arc array 1801 in the disk 1530 is an array where arcs are sorted in both an order of a state ID of a source state and an order of a label (input label) of an arc having the same source state to arrange data of respective arcs. Detailed description of the arc array 1801 is omitted herein.

Moreover, arc indices 1802 arranged in the memory 1520 indicate a start position of arcs in each state in the arc array. The arc indices 1802 are constituted by array-type data sorted in accordance with the state ID similarly to the example depicted in FIG. 17. Detailed description of the arc indices 1802 is also omitted herein.

According to the example depicted in FIG. 17, the input label array 1703 store labels (input labels) corresponding to the arcs in the arc array 1701 in an array identical to the array of the arc array 1701. On the other hand, according to the example depicted in FIG. 18, an input label array 1803 stores data for calculating a position of a page where a target arc is arranged. Specifically, the arc array 1801 is separated every 256 arcs (e.g., for each page), and only the initial input labels of the arc array 1801 having 256 arcs are stored in the input label array 1803. The 256 arcs correspond to 4 KB, i.e., one page. Accordingly, the input label array 1803 stores data for calculating a position of a page where a target arc is arranged. It is therefore possible to specify the page containing the target arc, and read data of the arcs corresponding to one page from the disk 1530 into the memory 1520.

At the time of search for a language model WFST arranged in the disk 1530 in the form of the arc array 1801, the CPU 1510 initially specifies a start position of arcs of a corresponding state in the arc array 1801 on the basis of an element corresponding to a state ID with reference to the arc indices 1802 in the memory 1520, and calculates a page range where a target arc is likely to be present. Subsequently, the CPU 1510 compares initial labels of respective pages in each of which the target arc is likely to be present with input labels with reference to the input label array 1803 in the memory 1520, and specifies the page where the target arc is present. Thereafter, the CPU 1510 executes access to the disk 1530, reads data of one page, i.e., 256 arcs into the memory 1520, and then searches the target arc from the 256 arcs.

According to the method proposed in this article, the size of the WFST (large) access data arranged in the memory 1520 can be reduced with substantially no necessity of changing the method and the processing time proposed in article G-2. The data volume of the input label array 1803 is reduced to one 256th of the data volume of the input label array 1703 depicted in FIG. 17.

Moreover, the number of disk accesses can be further reduced by rearranging the arc array 1801 in such a manner as to increase useful arcs as much as possible in the 256 arcs read by one disk access. Increasing useful arcs as much as possible herein refers to insertion of arcs highly likely to be simultaneously used into the same page (group of 256 arcs). As described above, it is necessary to collect arcs extending from the same state (node), sort the arcs in the order of the label, and arrange the arcs in the arc array as described above. Accordingly, the arcs highly likely to be simultaneously used need to be collected into one group and rearranged (that is, reset of the state ID is needed).

For example, a method based on a structure of a WFST may be adopted as an arc rearrangement method. Specifically, this method arranges arcs extending from connected states (nodes) in the WFST in such a manner as to collect these arcs close to each other as much as possible.

Alternatively, adoptable is such a method which rearranges arcs on the basis of statistics of access patterns of a language model. This is a method which actually operates WFST search, and rearranges arcs on the basis of statistics of access patterns of a language model during operation. This method gathers statistics on the basis of actual speech sound, and therefore further achieves optimization for a particular service.

Moreover, pre-reading of arcs of a language model may be performed to reduce the processing time. This method predicts an arc likely to be subsequently read from the disk 1530, and reads the arc into the memory 1520 beforehand, thereby reducing the processing time by a length of latency of disk access. In a case where prediction is wrong, disk access is wasted. However, this method is effective for reduction of the processing time as long as IOPS of the disk 1530 does not become a bottle neck. A predictor of access patterns of a language model can be learned using a sequence model such as an HMM and an RNN (Recurrent Neural Network). At the time of execution of WFST search, a model learned beforehand may be used, or on-line learning may be performed during processing by the speech recognition system 1500.

### G-4. Functional Configuration Example

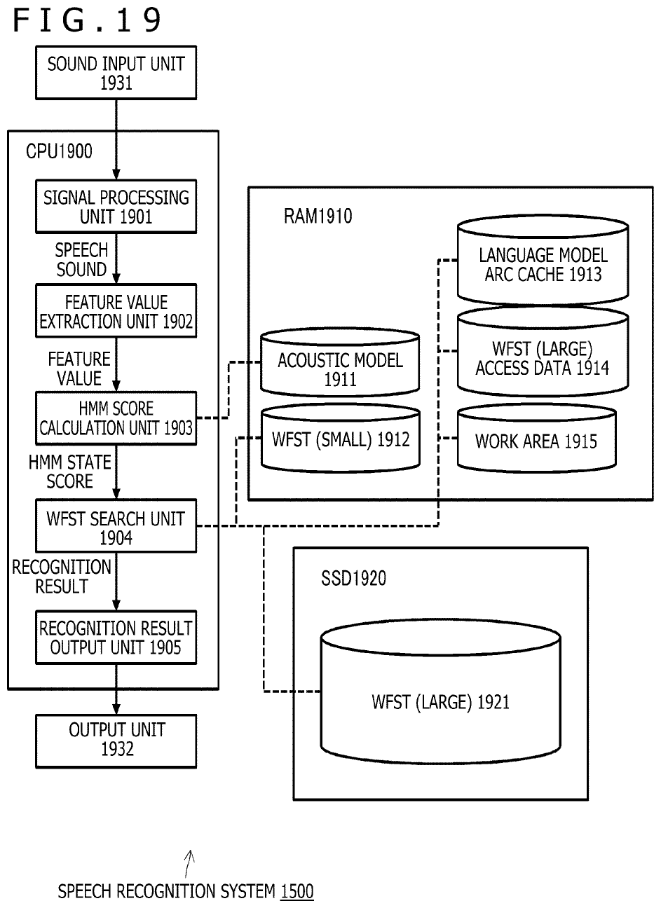

FIG. 19 depicts a specific functional configuration example of a speech recognition system 1500 to which the technology proposed in the second embodiment is applied.

A signal processing unit 1901, a feature value extraction unit 1902, an HMM score calculation unit 1903, a WFST search unit 1904, and a recognition result output unit 1905 are disposed within a CPU 1900. In reality, these function modules indicated by the reference numbers 1901 to 1905 may be software programs executed by the CPU 1900. Alternatively, the functional modules indicated by the reference numbers 1901 to 1905 may be implemented by using a many-core arithmetic unit such as a GPU instead of the CPU, or by a combination of the CPU and the GPU.

A speech input unit 1931 is constituted by a microphone or the like, and collects speech signals. The signal processing unit 1901 performs predetermined digital processing for the speech signals received by the speech input unit 1931. The feature value extraction unit 1902 extracts feature values of speech sound using a known technology such as Fourier transform and mel filter bank. The HMM score calculation unit 1903 receives information associated with the feature values of the speech sound, and calculates scores of respective HMM states using an acoustic model 1911 within a RAM 1910. A GMM or a DNN is used for an HMM.

The WFST search unit 1904 receives HMM state scores, and performs a search process based on on-the-fly synthesis using a small graph (small WFST model) in the RAM (Random Access Memory) 1910 as the memory described above, and a large graph (large WFST model) 1921 in an SSD 1920 as the disk described above.

The large graph (large WFST model) 1921 in the SSD 1920 is an arc array. The arc array is an array where arcs are sorted in both an order of a state ID of a source state and an order of a label (input label) of an arc having the same source state (described above) to arrange data of the respective arcs. The WFST search unit 1904 is capable of accessing the arc array within the SSD 1920 at high speed by utilizing arc indices and an input label array stored in the RAM 1910 as WFST model (large) access data 1914.

Moreover, when the WFST search unit 1904 performs a WFST search process, arcs once read from the SSD 1920 are stored in units of page in a language model arc cache 1913 in the RAM 1910. Furthermore, data such as a token during WFST search is temporarily stored in a work area 1915 within the RAM 1910.

Processes from signal processing to WFST search are repeated within the CPU 1900 until input of speech data from the speech input unit 1931 ends (in other words, until an end of an utterance). After an end of input of speech data, the WFST search unit 1904 subsequently outputs a recognition result extracted from the most probable hypothesis to the recognition result output unit 1905. Thereafter, the recognition result output unit 1905 performs processing for displaying or outputting the recognition result using an output unit 1932 constituted by a display, a speaker, or the like.

Note that the speech recognition system 1500 may be configured to function as a device including at least either the speech input unit 1931 or the output unit 1932. Alternatively, the CPU 1900 and the GPU 320 may be mounted within a server in a cloud, while the speech input unit 441 and the output unit 442 may be configured to function as a speech agent device (described below).

### G-5. System Operation

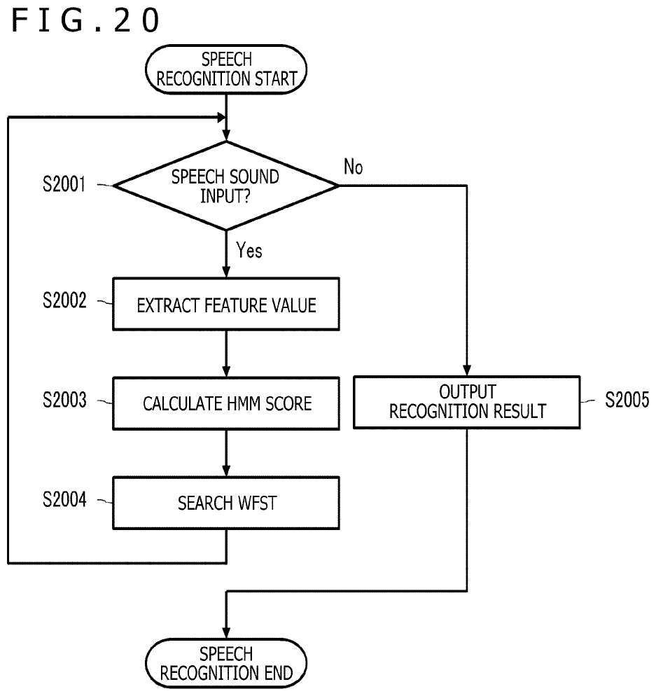

FIG. 20 presents a general processing procedure for speech recognition in a form of a flowchart, executed by the speech recognition system 1500 depicted in FIG. 19.

When speech sound is input to the speech input unit 1931 (Yes in step S2001), speech data obtained after digital processing by the signal processing unit 1901 is separated every ten milliseconds, for example, and input to the feature value extraction unit 1902.

The feature value extraction unit 1902 extracts feature values of the speech sound using a known technology such as Fourier transform and mel filter bank on the basis of the speech data obtained after digital processing by the signal processing unit 1901 (step S1902), and inputs feature value data to the HMM score calculation unit 1903.

Subsequently, the HMM score calculation unit 1903 receives information associated with the feature values of the speech sound, and calculates scores of respective HMM states using the acoustic model 1921 (step S2003).

Thereafter, the WFST search unit 1904 receives HMM state scores, and performs a search process based on on-the-fly synthesis using a small graph (small WFST model) 1912 in the RAM 1911, and the large graph (large WFST model) 1921 in the SSD 1920 (step S2004).

In step S2004, the WFST search unit 1904 initially causes transition of a token on the small graph 1912 in the RAM 1911. In a case where a word is output from the small graph by this transition, the WFST search unit 1904 causes transition on the large graph 1921 in the SSD 1920. At this time, the WFST search unit 1904 specifies a page where necessary arcs are arranged by utilizing arc indices and an input label array stored in the RAM 1910 as the WFST model (large) access data 1914. When a page containing the corresponding arcs is present in the language model arc cache 1913, the WFST search unit 1904 reads the arcs from this page. When such a page is absent, the WFST search unit 1904 reads the arcs from the large graph 1921 in the SSD 1920. Then, the WFST search unit 1904 searches a target arc from the read page, and causes transition of a token on the large graph using data of this arc.

Until arrival at a final end of the input speech (Yes in step S2001), processing from steps S2002 to S2004 described above is repeatedly executed for the speech data separated every ten milliseconds, for example.

Moreover, when the end of the input speech sound is reached (No in step S2001), the WFST search unit 1904 selects the most probable hypothesis from tokens in the work area 1915 of the RAM 1910, and outputs the selected hypothesis as a recognition result. Thereafter, the recognition result output unit 1905 performs processing for displaying or outputting the recognition result using the output unit 1932 constituted by a display, a speaker, or the like (step S2005).

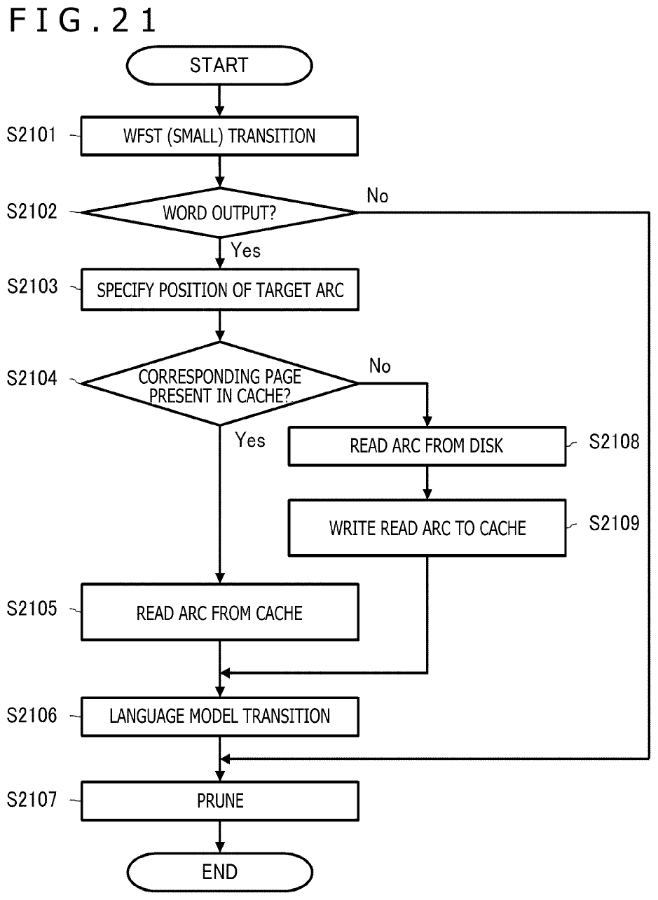

FIG. 21 presents an example of a detailed processing procedure of the WFST search process in a form of a flowchart, executed in step S2004 in the flowchart presented in FIG. 20. Note that the processing procedure depicted in FIG. 21 follows the disk access method explained in article G-2 described above (see FIG. 17).

The WFST search unit 1904 causes transition of a token on the small graph 1912 (small WFST model) in the RAM 1910 (step S2101).

In a case where no word is output from the arc to which the token has transited herein (No in step S2102), the WFST search unit 1904 prunes the entire hypotheses (step S2107), and ends the present process.

In a case where a word is output from the arc to which the token has transited (Yes in step S2102), the WFST search unit 1904 specifies a position of a target arc in the WFST model (large) 1921 using the WFST (large) access data 1914 (step S2103). The WFST search unit 1904 initially specifies a start position of a state ID of a source state of a target arc in the arc array with reference to the arc indices within the WFTS (large) access data 1914. Subsequently, the WFST search unit 1904 specifies the position of the target arc in the arc array by searching an input label of the target arc on the basis of an element at the same start position in the input label array within the WFST (large) access data 1914.

Thereafter, the WFST search unit 1904 checks whether or not a corresponding page (i.e., a page containing data of the target arc) is present within the language model arc cache 1913 (step S2104).

In a case where the corresponding page is already present within the language model arc cache 1913 (Yes step S2104), the WFST search unit 1904 reads data of the target arc from the language model arc cache 1913 (step S2105), and causes transition of a token on the large graph (step S2106).

On the other hand, in a case where the corresponding page is absent within the language model arc cache 1913 (No in step S2104), the WFST search unit 1904 reads a page containing the position specified in step S2103 from the WFST model (large) 1921 arranged in the SSD 1920, i.e., the arc array (step S2108), and writes the page to the language model arc cache 1913 (step S2109). Thereafter, the WFST search unit 1904 searches the target arc from the read page, and causes transition of a token on the large graph using data of this arc (step S2106).

Then, after transition of all hypotheses, the WFST search unit 1904 prunes the entire hypotheses (step S2107), and ends the present process.

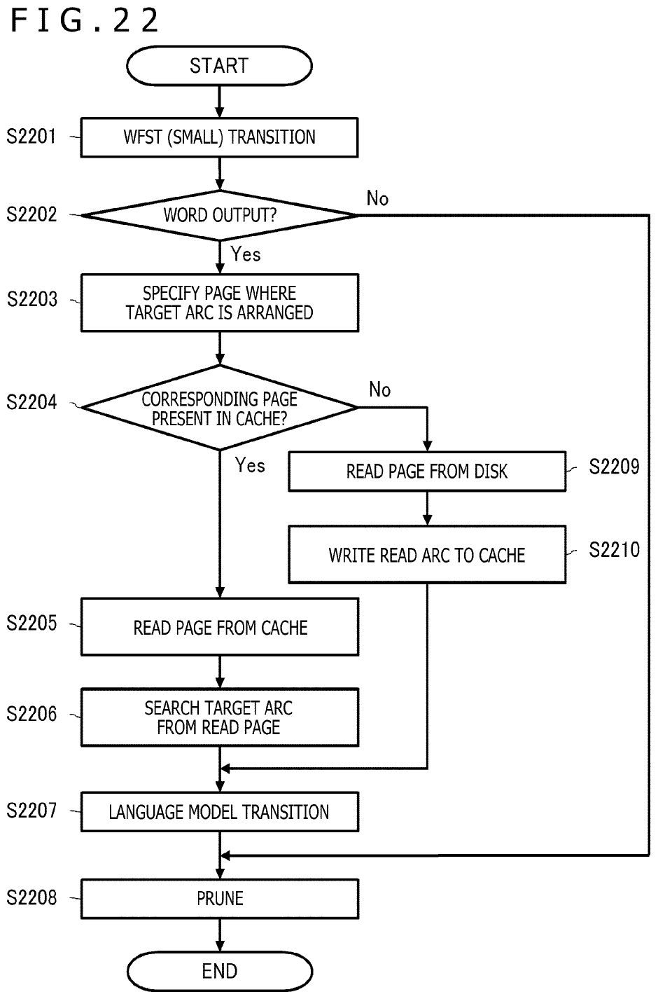

In addition, FIG. 22 presents another example of the detailed processing procedure of the WFST search process in a form of a flowchart, executed in step S2004 in the flowchart presented in FIG. 20. Note that the processing procedure depicted in FIG. 22 follows the disk access method explained in article G-3 described above (see FIG. 18).

The WFST search unit 1904 causes transition of a token on the small graph 1912 (small WFST model) in the RAM 1910 (step S2201).

In a case where no word is output from the arc to which the token has transited herein (No in step S2202), the WFST search unit 1904 prunes the entire hypotheses (step S2208), and ends the present process.

In a case where a word is output from the arc to which the token has transited (Yes in step S2202), the WFST search unit 1904 specifies a page where a target arc is arranged in the WFTS model (large) 1921 using the WFST (large) access data 1914 (step S2203). The WFST search unit 1904 initially specifies a start position of an arc in a corresponding state in the arc array on the basis of an element corresponding to a state ID with reference to the arc indices within the WFST (large) access data 1914, and calculates a page range where the target arc is likely to be present. Subsequently, the CPU 1510 compares initial labels of respective pages in each of which the target arc is likely to be present with input labels with reference to the input label array within the WFST (large) access data 1914, and specifies the page where the target arc is present.

Thereafter, the WFST search unit 1904 checks whether or not the corresponding page is present within the language model arc cache 1913 (step S2204).

In a case where the corresponding page is already present within the language model arc cache 1913 (Yes step S2204), the WFST search unit 1904 reads data of the corresponding page, i.e., 256 arcs from the language model arc cache 1913 (step S2205), and searches the target arc from the 256 arcs (step S2206).

On the other hand, in a case where the corresponding page is absent within the language model arc cache 1913 (No in step S2204), the WFST search unit 1904 reads a page containing the position specified in step S2203 from the WFST model (large) 1921 arranged in the SSD 1920, i.e., the arc array (step S2209), and writes the page to the language model arc cache 1913 (step S2210).

Thereafter, the WFST search unit 1904 searches the target arc from the read page (step S2206), and causes transition of a token on the large graph using data of this arc (step S2207).

Then, after transition of all hypotheses, the WFST search unit 1904 prunes the entire hypotheses (step S2208), and ends the present process.

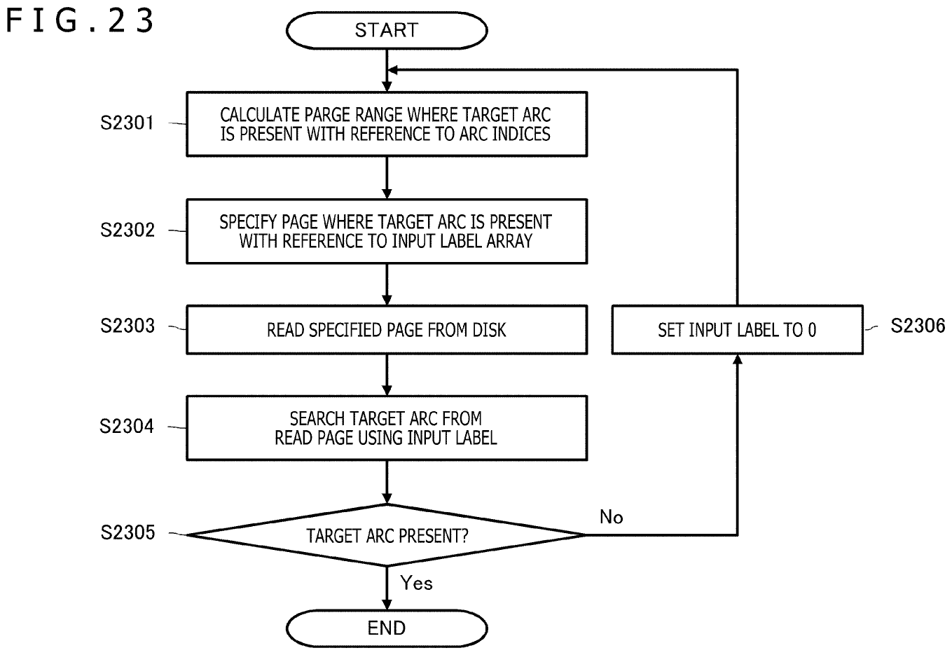

FIG. 23 presents a detailed processing procedure for specifying a page where a target arc is arranged in the WFTS model (large) 1921 (i.e., arc array) in a form of a flowchart, executed in step S2203 in the flowchart presented in FIG. 22.

The WFST search unit 1904 initially calculates a page range where the target arc is likely to be present with reference to an element corresponding to a state ID of the target arc and a next element in the arc indices contained in the WFST (large) access data 1914 (step S2301).

For example, when the state ID of the target arc is “0” in the arc indices 1802 depicted in FIG. 18, it can be specified that the target arc is present in a page 0 on the basis of a fact that arcs extending from a source state of the state ID “0” lie within the range of the first to the 256th arcs with reference to a first element “0” and a second (i.e., state ID “4”) element “4.”

Needless to say, in a case where the element corresponding to the state ID of the target arc in the arc indices is separated from the next element by 256 or more elements, the page range where the target arc is likely to be present covers a plurality of pages. For example, in a case where the start position of the state ID of the target arc in the arc array is the Nth position, the initial arc extending from this source state is present in a [N/256]th page (note that [X] is a largest integer in a range equal to or smaller than a real number X). Specifically, in a case where the state ID of the source state of the target arc is the tenth position in the arc indices, and that the tenth element and the subsequent eleventh element are 300 and 900, respectively, the target arc is present in a range from [300/256]=first page to [900/256]=third page.

Subsequently, the WFST search unit 1904 compares initial labels of respective pages corresponding to the page range calculated in preceding step S2301 with the input label of the target arc with reference to the input label array within the WFST (large) access data 1914, and specifies the page where the target arc is present (step S2302).

A plurality of arcs extends from each of the states. The arcs having the same source state are sorted in accordance with a label (input label) (described above). Accordingly, the page can be specified by comparing the initial labels of the respective pages with the input label of the target arc. For example, suppose that the input label of the target arc is 100, that the page range where the target arc is likely to be present lies between the first page and the third page, and that the respective initial labels of the first page, the second page, and the third page in the input label array are 300, 50, and 150, respectively. The initial label of the first page is located out of the range of the input label of the target arc, and therefore is obviously the input label in the previous state. Accordingly, the input label of the target arc is present between a start position of the second page and a start position of the third page. It is therefore specified that the target arc is present in the second page.

Subsequently, the WFST search unit 1904 reads the specified page from the large graph 1921 in the SSD 1920, i.e., from the arc array (step S2303).

Thereafter, the WFST search unit 1904 searches the target arc using the input label from the 256 arcs read from the arc array in the SSD 1920 (step S2304).

Each of the read arcs has input label information (e.g., see FIG. 14). At the time of reference to the arc indices in step S2301, the range of the arcs extending from the source state of the state ID of the target arc in the 256 arcs is recognizable. Specifically, the difference between the element corresponding to the state ID of the target arc and the next element corresponds to the number of arcs extending from this state. Accordingly, the single target arc can be specified (or absence of the target arc is recognizable) by comparison between the input labels within this range.

Thereafter, the WFST search unit 1904 checks whether or not the target arc is present (step S2305). In a case where the target arc is present in the page read from the SSD 1920 (Yes in step S2305), the WFST search unit 1904 ends the present process.

On the other hand, in a case where the target arc is absent in the read page (No in step S2305), the WFST search unit 1904 transits to a back-off state. Specifically, the WFST search unit 1904 sets the input label to 0 (step S2306), returns to step S2301, and repeats processing similar to the above. The label 0 indicates an arc for back-off transition.

### G-6. System Having Arc Pre-Reading Function

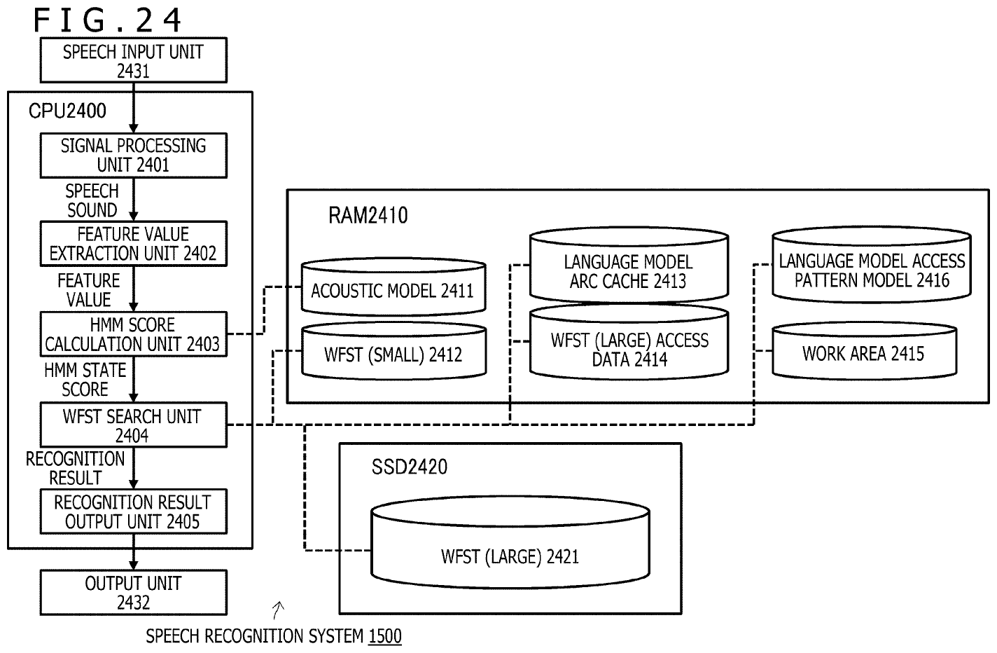

FIG. 24 depicts a specific functional configuration example of the speech recognition system 1500 having an arc pre-reading function.

A signal processing unit 2401, a feature value extraction unit 2402, an HMM score calculation unit 2403, a WFST search unit 2404, and a recognition result output unit 2405 are disposed within a CPU 2400. In reality, these function modules indicated by the reference numbers 2401 to 2405 may be software programs executed by the CPU 2400. In addition, the respective function modules indicated by the reference numbers 2401 to 2405 basically perform functions or roles similar to those of the function modules having the same names within the speech recognition system 1500 depicted in FIG. 19. Accordingly, detailed description of these function modules is omitted herein.

Moreover, a RAM 2410 corresponds to the memory described above, while an SSD 2420 corresponds to the disk described above. An acoustic model 2411 used for score calculation of an HMM state, a small graph (small WFST model) 2512, a language model arc cache 2413 storing arcs once read from the SSD 2420 in units of page, and a WFST model (large) access data 2414 constituted by arc indices, an input label array, and the like are arranged in the RAM 2410. On the other hand, a large graph (large WFST model) 2421 is arranged in the SSD 2420.

According to the speech recognition system 1500 depicted in FIG. 24, a language model access pattern model 2416 used for pre-reading of arcs of a language model is further arranged in the RAM 2410. The pre-reading function of pre-reading arcs of a language model will be hereinafter described.

According to the speech recognition system 1500 depicted in FIG. 24, arcs are read in advance from the SSD 2420 to the language model arc cache 2413 within the RAM 2410 before the time of actual necessity of the arcs to hide reading latency of the disk, i.e., the SSD 2420. The WFST search unit 2404 (or another (not-depicted) function module executed by the CPU 2400) predicts an arc likely to be needed next using the language model access pattern model 2416 arranged within the RAM 2410, and executes pre-reading.

The language model access pattern model 2416 may be constituted by a sequence model such as a pre-learned HMM and an LSTM (Long-Short Term Memory), or may be learned online while operating processes of the speech recognition system 1500. The language model access pattern model 2416 receives input of an access pattern to a previous arc (one access before or a plurality of accesses before), and outputs an arc (or page) highly likely to be accessed next (or N arcs or pages from the high-order arc or page). The pre-read arc is arranged in the language model arc cache 2413 within the RAM 2410.

If pre-reading is completed as a result of true prediction, the arc accessed in the next process is already present in the language model arc cache 2413. In this case, reading from the SSD 2320 is unnecessary, and therefore an increase in the processing time due to latency of disk access is avoidable.

Note that pre-reading may be performed either in units of arc or in units of page. When the language model arc cache 2413 is a cache in units of arc, pre-reading is performed in units of arc. When the language model arc cache 2413 is a cache in units of page, pre-reading is performed in units of page.

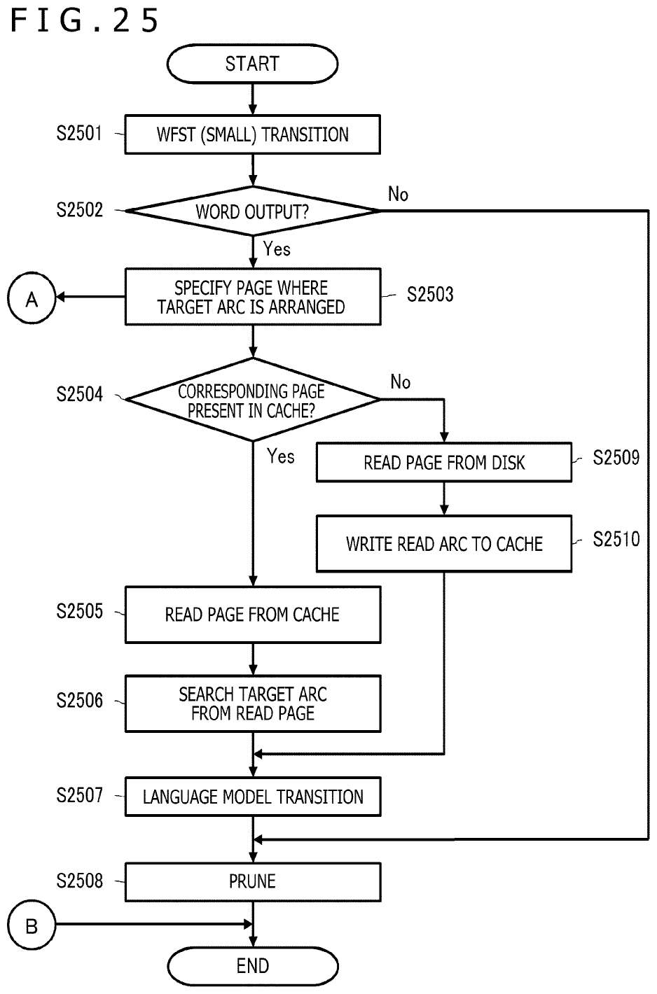

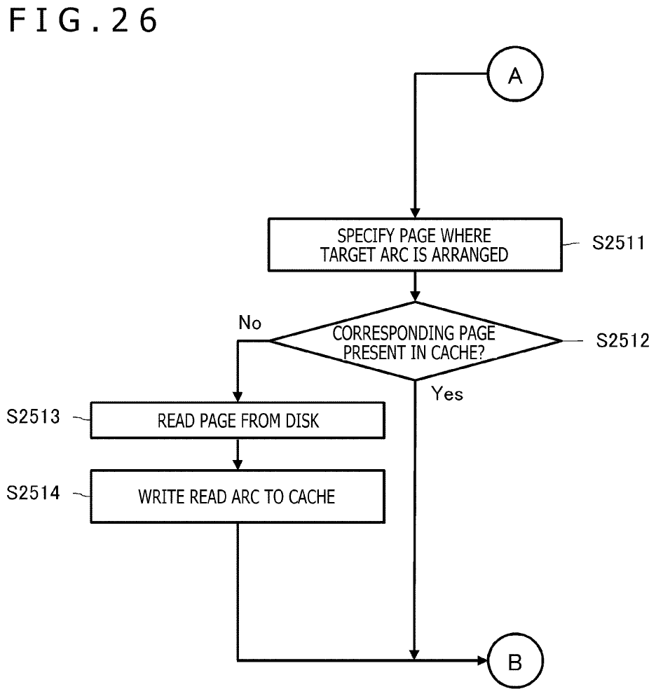

FIGS. 25 and 26 present a detailed processing procedure of the WFST search process in a form of a flowchart, executed by the WFST search unit 2404 in the speech recognition system 1500 depicted in FIG. 24. According to the processing procedure depicted in the figure, arc pre-reading is performed concurrently with the WFST search process. Note that the processing procedure presented in the figure follows the disk access method explained in article G-3 described above (see FIG. 18).

The WFST search unit 2404 causes transition of a token on the small graph 1912 (small WFST model) in the RAM 1910 (step S2501).

In a case where no word is output from the arc to which the token has transited herein (No in step S2502), the WFST search unit 2404 prunes the entire hypotheses (step S2508), and ends the present process.

In a case where a word is output from the arc to which the token has transited (Yes in step S2502), the WFST search unit 2404 specifies a page where a target arc is arranged in the WFTS model (large) 1921 using the WFST (large) access data 2414 (step S2503). Step S2503 is basically performed in accordance with the processing procedure presented in FIG. 23.

Thereafter, the WFST search unit 2404 checks whether or not the corresponding page is present within the language model arc cache 2413 (step S2504). In a case where the corresponding page is already present within the language model arc cache 2413 (Yes step S2504), the WFST search unit 2404 reads the corresponding page from the language model arc cache 2413 (step S2505), and searches the target arc from this page (step S2506).

On the other hand, in a case where the corresponding page is absent within the language model arc cache 2413 (No in step S2504), the WFST search unit 2404 reads a page containing the position specified in step S2503 from the WFST model (large) 2421 arranged in the SSD 2420, i.e., the arc array (step S2509), and writes the page to the language model arc cache 2413 (step S2510).

Thereafter, the WFST search unit 2404 searches the target arc from the read page (step S2506), and causes transition of a token on the large graph (step S2507). Then, after transition of all hypotheses, the WFST search unit 2404 prunes the entire hypotheses (step S2508), and ends the present process.

Moreover, the WFST search unit 2404 (or a function module for pre-reading executed by the CPU 2400) performs the arc pre-reading process concurrently with the process for specifying the page where the target arc is arranged (step S2503).

The WFST search unit 2404 inputs a page access pattern to the language model access pattern model 2416 (step S2511). The language model access pattern model 2416 receives input of an access pattern to a previous arc (one access before or a plurality of accesses before), and outputs a page highly likely to be accessed next.

Thereafter, the WFST search unit 2404 checks whether or not a page output from the language model access pattern model 2416 and highly likely to be accessed next is present within the language model arc cache 2413 (step S2512). In a case where the corresponding page is already present within the language model arc cache 2413 herein (Yes in step S2504), pre-reading is unnecessary. In this case, the present process ends.

On the other hand, in a case where the corresponding page is absent within the language model arc cache 2413 (No step S2512), the WFST search unit 2404 performs pre-reading of the page output from the language model access pattern model 2416 in step S2511. Specifically, the WFST search unit 2404 reads the corresponding page from the WFST model (large) 2421 arranged in the SSD 2420, i.e., the arc array (step S2513), and writes the page to the language model arc cache 2413 (step S2514).

### H. On-the-Fly Synthesis Using Disk in Hybrid Environment

Described above in article G has been the technology which divides WFST data into two parts, arranges the two parts separately in the memory and the disk, and achieves on-the-fly synthesis using the CPU (i.e., single processor). On the other hand, described in this article will be a technology which achieves on-the-fly synthesis using a disk in a hybrid environment constituted by a CPU and a GPU.

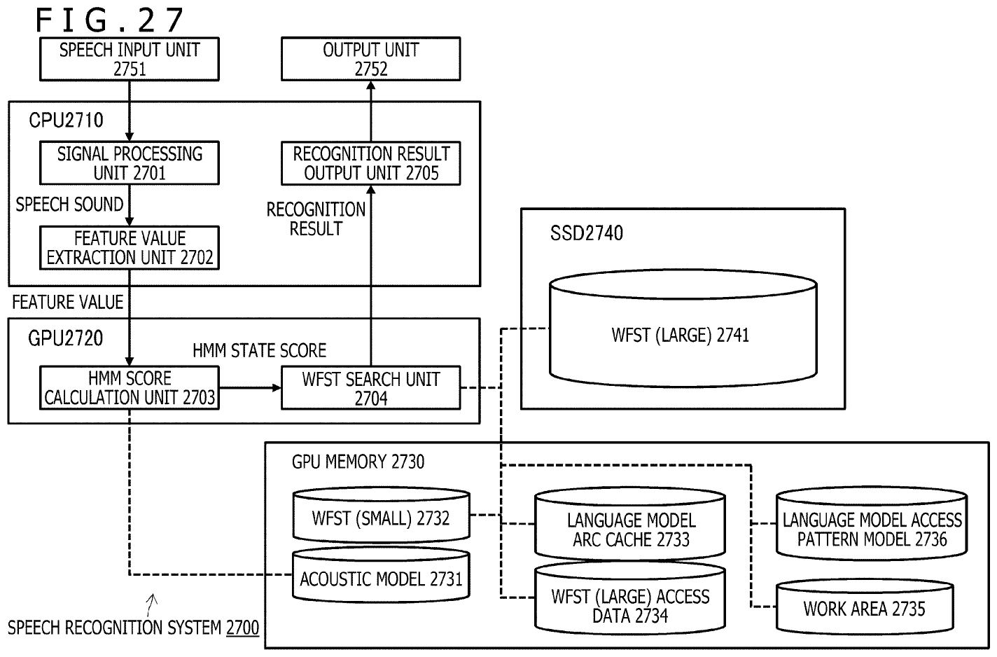

FIG. 27 depicts a functional configuration example of a speech recognition system 2700 which achieves on-the-fly synthesis using a disk in a hybrid environment.

The speech recognition system 2700 includes a CPU 2710 and a GPU 2720 as processors for executing processing associated with a speech recognition process. Respective function modules of a signal processing unit 2701, a feature value extraction unit 2702, and a recognition result processing unit 2705 are disposed within the CPU 2710. In addition, respective function modules constituting an HMM score calculation unit 2703 and a WFST search unit 2704 are disposed within the GPU 2720. In reality, these function modules indicated by the reference numbers 2701 to 2705 may be software programs executed by the CPU 2710 and the GPU 2720. Moreover, while an SSD 2740 is used as a disk in the speech recognition system 2700, a built-in memory (hereinafter referred to as “GPU memory”) 2730 of the GPU 2720 is used as a memory.

A speech input unit 2751 is constituted by a microphone or the like, and inputs collected speech signals to the CPU 2710. The signal processing unit 2701 in the CPU 2710 performs predetermined digital processing for the speech signals. In addition, the feature value extraction unit 2702 extracts feature values of the speech sound, and outputs the feature values to the GPU 2720.

The HMM score calculation unit 2703 in the GPU 2720 receives information associated with the feature values of the speech sound, and calculates scores of respective HMM states using an acoustic model 2731 within the GPU memory 2730. Thereafter, the WFST search unit 2704 receives HMM state scores, and performs a search process based on on-the-fly synthesis using a small graph (small WFST model) 2732 within the GPU memory 2730, and a large graph (large WFST model) 2741 in the SSD 2740.

The large graph (large WFST model) 2741 in the SSD 2740 is an arc array. The WFST search unit 2704 is capable of accessing the arc array within the SSD 2740 at high speed by utilizing arc indices and an input label array stored in the GPU memory 2730 as WFST model (large) access data 2734 (same as above).

When the WFST search unit 2704 performs the WFST search process, arcs once read from the SSD 2740 are stored in units of page in a language model arc cache 2733 within the GPU memory 2730. Moreover, data such as a token during WFST search is temporarily stored in a work area 2735 within the GPU memory 2730.

Furthermore, when performing the WFST search process, the WFST search unit 2704 concurrently carries out the arc pre-reading process. The WFST search unit 2704 inputs a page access pattern to a language model access pattern model 2736 within the GPU memory 2730. Thereafter, the WFST search unit 2704 reads a page output from the language model access pattern model 2736 and highly likely to be accessed next from the WFST model (large) 2741 within the SSD 2740, and writes the page to the language model arc cache 2733 within the GPU memory 2730.

The CPU 2710 and the GPU 2720 repeat processes from signal processing to WFST search until input of speech data from the speech input unit 2751 ends (in other words, until an end of an utterance). After the end of input of speech data, the WFST search unit 2704 within the GPU 2720 subsequently outputs a recognition result extracted from the most probable hypothesis to the recognition result output unit 2705 on the CPU 2710 side. Thereafter, the recognition result output unit 2705 performs processing for displaying or outputting the recognition result using an output unit 2752 constituted by a display, a speaker, or the like.

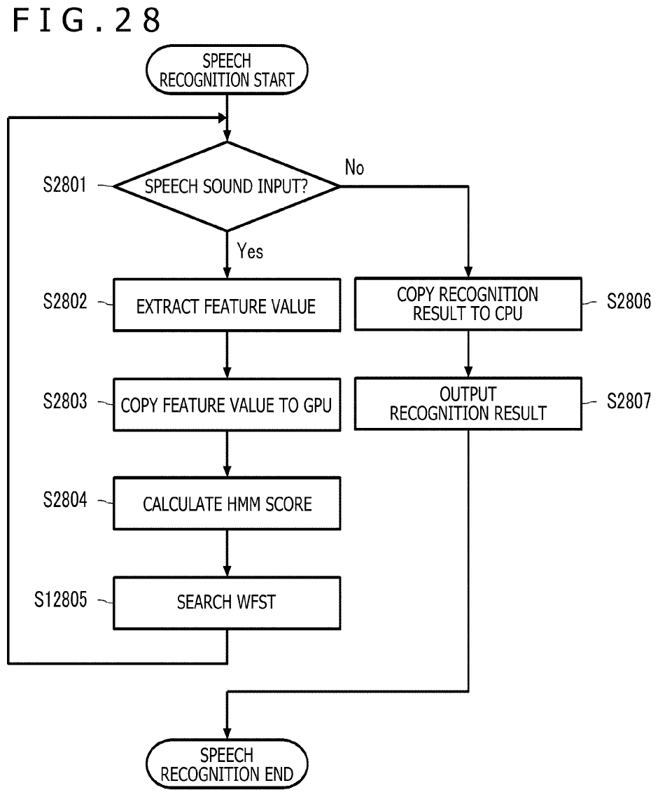

FIG. 28 presents a general processing procedure for speech recognition in a form of a flowchart, executed by the speech recognition system 2700 depicted in FIG. 27.

When speech sound is input to the speech input unit 2751 (Yes in step S2801), speech data obtained after digital processing by the signal processing unit 2701 is separated every ten milliseconds, for example, and input to the feature value extraction unit 2702.

The feature value extraction unit 2702 extracts feature values of speech sound using a known technology such as Fourier transform and mel filter bank on the basis of speech data obtained after digital processing by the signal processing unit 2701 (step S2802). As depicted in FIG. 27, in a case where HMM score calculation is performed using the GPU 2720, feature value data is copied to the work area 2735 of the GPU memory 2730, and input to the HMM score calculation unit 2703 (step S2803).

Subsequently, the HMM score calculation unit 273 receives information associated with the feature values of the speech sound and calculates scores of respective HMM states using the acoustic model 2731 within the GPU memory 2730 (step S2804).

Thereafter, the WFST search unit 2704 receives HMM state scores, and performs a search process based on on-the-fly synthesis using the small graph (small WFST model) 2732 in the GPU memory 2730, the language model arc cache 2733, and the large graph (large WFST model) 2741 in the SSD 2740 (step S2805).

In step S2805, the WFST search unit 2704 initially causes transition of a token on the small graph. In a case where a word is output from the small graph by this transition, the WFST search unit 2704 receives an input constituted by an ID of a source state (state before transition) and an input label, acquires information associated with arcs of the large graph from the language model arc cache 2733, and causes transition of a token on the large graph. Moreover, in a case where a cache miss is produced in the language model arc cache 2733, the WFST search unit 2704 reads a target arc by searching the large graph (large WFST model) 2741 in the SSD 2740. The WFST search unit 2704 may search the large graph (large WFST model) 2741 in accordance with the processing procedure presented in FIGS. 25 and 26, for example, to concurrently perform arc pre-reading. Then, after transition of all hypotheses, the WFST search unit 2704 prunes the entire hypotheses.

Until arrival at a final end of the input speech (Yes in step S2801), processing from steps S2802 to S2805 described above is repeatedly executed for the speech data separated every ten milliseconds, for example.

In addition, after arrival at the final end of the input speech sound (No in step S2801), the character string of the speech recognition result obtained by the WFST search unit 2704 is copied from the work area 2735 in the GPU memory 2730 to a main memory on the CPU 2710 side (step S2806).

Thereafter, the recognition result output processing unit 2705 on the CPU 2710 side performs processing for displaying or outputting the recognition result using the output unit 2752 constituted by a display, a speaker, or the like (step S2807).

### I. Summary

Advantageous effects offered by the technology according to the second embodiment will be touched upon herein.

According to the speech recognition system to which the technology of the second embodiment is applied, WFST data is divided into two parts, the two parts are separately arranged in the memory and the disk, and on-the-fly synthesis is performed. In this manner, real-time processing is achievable while reducing an increase in the processing time produced by arranging all WFST data in the disk. In this case, following advantages are offered.

(a) Large-scale graph search is executable by a system having a limited memory capacity.

(b) High-speed graph search process is executable even with arrangement of a WFST model in a disk.

(c) A larger WFST model is usable by the same memory use volume.

### Third Embodiment

### J. Specific Example

Described herein will be a specific example of a product incorporating a speech recognition system to which a large-scale graph search technology according to the present disclosure is applied.

A service called an “agent,” an “assistant,” or a “smart speaker” has been increasingly spreading in recent years as a service presenting various types of information to a user while having a dialog with the user by speech sound or the like in accordance with use applications and situations. For example, a speech agent is known as a service which performs power on-off, channel selection, and volume control of TV, changes a temperature setting of a refrigerator, and performs power on-off or adjustment operations of home appliances such as lighting and an air conditioner. The speech agent is further capable of giving a reply by speech sound to an inquiry concerning a weather forecast, stock and exchange information, or news. The speech agent is also capable of receiving orders of products, and reading contents of purchased books aloud.

For example, an agent function is provided by a cooperative operation between an agent device installed around a user in the home or the like, and an agent service constructed in a cloud (e.g., see PTL 2). The agent device chiefly provides a user interface such as a speech input for receiving speech sound uttered by the user, and a speech output for giving a reply by speech sound to an inquiry from the user. On the other hand, the agent service side recognizes speech sound input through the agent device, and analyzes a meaning of the speech sound. Moreover, the agent service side may also execute heavy-load processing, such as processing for information search in accordance with an inquiry from the user, and speech analysis based on a processing result.

### J-1. Handling of Home Appliances by Speech Sound

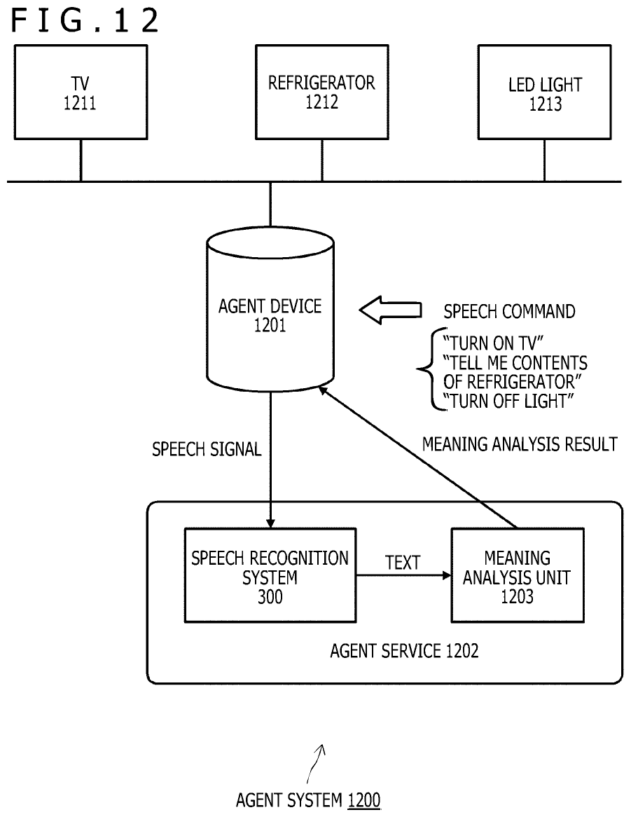

FIG. 12 depicts a functional configuration example of an agent system 1200 incorporating a speech recognition system to which the technology according to the present disclosure is applied. The agent system 1200 is constituted by an agent device 1201 and an agent service 1202.

For example, the agent device 1201 is provided around a user in the home or the like. The agent device 1201 interconnects various types of home appliances, such as TV 1211, a refrigerator 1212, an LED (Light Emitting Diode) light 1213, via a wired LAN (Local Area Network) such as Ethernet (registered trademark), or a wireless LAN such as Wi-Fi (registered trademark). Moreover, the agent device 1201 includes a speech input unit such as a microphone, and an output unit such as a speaker and a display.

The agent service 1202 includes a speech recognition system 1204 and a meaning analysis unit 1203. Note that the speech recognition system 1204 is assumed to have a functional configuration depicted in any one of FIGS. 4, 9, 19, 24, and 27, for example. Accordingly, detailed description of the speech recognition system 1204 is omitted herein.

For example, the agent service 1202 is configured to function as a server in a cloud. The agent device 1201 and the agent service 1202 are interconnected to each other via a wide area network, such as the Internet. However, it is possible to adopt a system configuration where the function of the agent service 1202 is incorporated in the agent device 1201.

The agent device 1201 transmits a speech signal which is generated by collecting a speech command uttered from the user to the agent service 1202. The speech command contains an instruction given to the home appliances, such as “turn on TV,” “tell me contents of the refrigerator,” and “turn off light.”

The agent service 1202 side performs a speech recognition process utilizing on-the-fly synthesis to output a speech recognition signal received by the speech recognition system 1204 as text of a recognition result. Subsequently, the meaning analysis unit 1203 analyzes meaning of the text of the recognition result, and returns a meaning analysis result to the agent device 1201.

The meaning analysis result of the speech command given by the user contains operation commands for the respective home appliances, such as power on-off, channel selection, and volume control of the TV 1211, a change of a temperature setting of the refrigerator 1212, and on-off and light volume control of the LED light 1213. The agent device 1201 transmits operation signals, such as power on-off, channel selection, and volume control of the TV 1211, operation signals such as a change of a temperature setting of the refrigerator 1212, and operation signals on-off and light volume control of the LED light 1213, via a network within the home on the basis of the meaning analysis result received from the agent service 1202.

### J-2. Large Vocabulary Recognition by Smartphone

A speech recognition system to which the technology according to the present disclosure is applied is capable of performing large vocabulary speech recognition for one million vocabulary words or more using a memory use volume of 3 GB or smaller. Accordingly, a speech recognition process is operable even by a smartphone having a memory capacity smaller than that of a server in a cloud. As a result, a sophisticated agent function based on a high-performance speech recognition process is achievable using a smartphone. For example, the server in the cloud corresponding to the part of the agent service 1202 included in the agent system 1200 depicted in FIG. 12 is replaceable with a smartphone.

### INDUSTRIAL APPLICABILITY

The technology according to the present disclosure has been described in detail with reference to the specific embodiments. However, it is apparent that those skilled in the art are allowed to make corrections and substitutions to the embodiments without departing from the scope of the subject matters of the technology according to the present disclosure.

While the embodiments applied to a WFST for speech recognition have been chiefly described in the present description as an example of graph search, use applications of the technology according to the present disclosure are not limited to this example. The technology according to the present disclosure is similarly applicable to other graph search processes for performing equivalent processing. The technology described in the first embodiment is similarly applicable to various cases in each of which a graph search process allowing on-the-fly synthesis is applied to a hybrid environment using a CPU and a GPU. Moreover, the technology described in the second embodiment is applicable not only to a combination of a main storage device and an auxiliary storage device, but also to a combination of any storage devices having different level of access performance and capacities, such as a combination of a GPU memory and an auxiliary storage device.

The technology according to the present disclosure achieves a large-scale graph search process for speech recognition using a GPU in a hybrid environment using a CPU and the GPU. Moreover, application targets of the technology according to the present disclosure are not limited to a GPU and a graph search process for speech recognition. The GPU is replaceable with a many-core arithmetic unit having a limited memory capacity (having a memory capacity smaller than a graph size), and the graph search process for speech recognition is replaceable with an ordinary graph search process.

Furthermore, the speech recognition system using a WFST as a system to which the technology of the present disclosure is applied is allowed to be incorporated in various types of information processing apparatuses or information terminals, such as a personal computer, a smartphone, a tablet, and a speech agent.

As apparent from above, the technology according to the present disclosure has been described only in the form of examples. Accordingly, contents of the present description should not be interpreted as limited contents. The claims should be taken into consideration for determining the subject matters of the technology according to the present disclosure.

Note that the technology according to the present disclosure can also have following configurations.

(1)

An information processing apparatus including:

an arithmetic operation unit;

a first storage device; and

a second storage device, in which

graph information is divided into two parts constituted by first graph information and second graph information,

the first graph information is arranged in the first storage device,

the second graph information is arranged in the second storage device, and

the arithmetic operation unit executes a graph search process using the first graph information arranged in the first storage device and the second graph information arranged in the second storage device.

(2)

The information processing apparatus according to (1) described above, in which

the first graph information has a size smaller than a size of the second graph information, and

the first storage device has a capacity smaller than a capacity of the second storage device.

(3)

The information processing apparatus according to (2) described above, in which

the graph information is a WFST model that represents an acoustic model, a pronunciation dictionary, and a language model of speech recognition,

the first graph is a small WFST model that is a small part of two divided parts of the WFST model, and

the second graph is a large WFST model that is a large part of the two divided parts of the WFST model.

(4)

The information processing apparatus according to (3) described above, in which

the first graph information is a small WFST model produced by synthesizing the acoustic model, the pronunciation dictionary, and a small part of two divided parts of the language model, the small part considering a connection of a first number of words or smaller, and

the second graph is a large WFST model that has a language model considering a connection of any number of words larger than the first number.

(5)

The information processing apparatus according to any one of (1) to (4) described above, in which, when reference to the second graph information is necessary during execution of a search process using the first graph information, the arithmetic operation unit copies a necessary part in the second graph information from the second storage device to the first storage device and continues the search process.

(6)

The information processing apparatus according to any one of (1) to (5) described above, in which

the arithmetic operation unit includes a first arithmetic operation unit including a GPU or a different type of many-core arithmetic unit, and a second arithmetic operation unit including a CPU,

the first storage device is a memory in the GPU, and

the second storage device is a local memory of the CPU.

(7)

The information processing apparatus according to (6) described above, in which

the graph information is a WFST model,

the first arithmetic operation unit causes transition of a token on a small WFST model, and

when state transition of a token on a large WFST model is needed as a result of output of a word from an arc to which the token has transited on the small WFST model, the first arithmetic operation unit performs an entire search process while copying data necessary for the process from the second storage device to the first storage device.

(8)

The information processing apparatus according to (6) described above, in which the first arithmetic operation unit calculates a position in the second storage device beforehand, the position where a necessary arc is arranged in the second graph.

(9)

The information processing apparatus according to (8) described above, in which

the first arithmetic operation unit and the second arithmetic operation unit have a common page table, and

in response to reference to an arc contained in a page absent in the first storage device by the first arithmetic operation unit, the corresponding page is transferred from the second storage device to the first storage device.

(10)

The information processing apparatus according to (8) described above, in which

a list of position information associated with the necessary arc and calculated by the first arithmetic operation unit beforehand is transmitted to the second arithmetic operation unit, and

the second arithmetic operation unit copies a necessary arc during graph search by the first arithmetic operation unit from the second storage device to the first storage device on the basis of the list.

(11)

The information processing apparatus according to (1) described above, in which the first storage device includes a cache that retains the second graph information.

(12)

The information processing apparatus according to (11) described above, in which the cache has a data structure that receives input of identification information indicating a source state and of an input label, and returns an arc.

(13)

The information processing apparatus according to (5) described above, in which

the information processing apparatus is applied to a speech recognition process,

the information processing apparatus executes feature value extraction that calculates a feature value of input speech sound using the second arithmetic operation unit, and the information processing apparatus executes, by using the first arithmetic calculation unit, HMM score calculation for calculating an HMM state score on the basis of the feature value, and a search process based on on-the-fly synthesis using the first graph information arranged in the first storage device and the second graph information arranged in the second storage device.

(14)

The information processing apparatus according to (13) described above, in which the information processing apparatus further executes, by using the second arithmetic operation unit, a process for outputting a speech recognition result obtained by the search process executed by the first arithmetic operation unit.

(15)

The information processing apparatus according to (4) described above, in which

the first storage device is a local memory of the arithmetic operation unit,

the second storage device is an auxiliary storage device,

the arithmetic operation unit causes transition of a token on a small WFST model, and

when state transition of a token on a large WFST model is necessary as a result of output of a word from an arc to which the token has transited on the small WFST model, the arithmetic operation unit performs the search process while copying data necessary for the process from the second storage device to the first storage device.

(15-1)

The information processing apparatus according to (15) described above, in which the arithmetic operation unit is constituted by a CPU or a GPU.

(15-2)

The information processing apparatus according to (15) described above, in which

the information processing apparatus is applied to a speech recognition process, and

the arithmetic calculation unit executes feature value extraction for calculating a feature value of input speech sound, HMM score calculation for calculating an HMM state score on the basis of the feature value, and a search process based on on-the-fly synthesis using the first graph information arranged in the first storage device and the second graph information arranged in the second storage device.

(16)

The information processing apparatus according to (15) described above, in which

the first storage device retains data for accessing the large WFST model in the second storage device, and

the arithmetic operation unit copies the data necessary for the process from the second storage device to the first storage device on the basis of the data for accessing.

(17)

The information processing apparatus according to (16) described above, in which

the large WFST model includes an arc array where arcs are sorted on the basis of a state ID of a source state and an input label,

the first storage device includes arc indices that store start positions of arcs in respective states in the arc array as the data for accessing, and an input label array that stores input labels corresponding to the arcs in the arc array and arranged in an array identical to the arc array, and

the arithmetic operation unit specifies a position where a target arc in the arc array is stored, and acquires data of the target arc from the arc array of the second storage device by specifying a start position of a state ID of a source state of the target arc in the arc array on the basis of the arc indices, and searching an input label of the target arc on the basis of an element at the start position in the input label array.

(18)

The information processing apparatus according to (16) described above, in which

the large WFST model includes an arc array where arcs are sorted on the basis of a state ID of a source state and an input label,

the first storage device includes arc indices that store start positions of arcs in respective states in the arc array as the data for accessing, and an input label array that stores input labels of initial elements in the arc arrays in pages each separating the arc array, and

the arithmetic operation unit calculates a page range where a target arc is present on the basis of the arc indices, specifies a page where the target arc is present from the page range on the basis of the input label array, and acquires the specified page from the arc array of the second storage device.

(19)

The information processing apparatus according to (17) or (18) described above, further including:

an access pattern model for predicting an arc or a page highly likely to be accessed next on the basis of a previous access history to arcs, in which

the arithmetic operation unit pre-reads an arc or a page predicted on the basis of the access pattern model from the second storage device.

(20)

An information processing method performed by an information processing apparatus that includes an arithmetic operation unit, a first storage device, and a second storage device, the information processing method including:

a step of arranging, in the first storage device, first graph information produced by dividing graph information;

a step of arranging, in the second storage device, second graph information produced by dividing the graph information; and

a step where the arithmetic operation unit executes a graph search process using the first graph information arranged in the first storage device and the second graph information arranged in the second storage device.

(101)

An information processing apparatus, in which

graph information is divided into two parts constituted by first graph information and second graph information,

the first graph information is arranged in a first memory of a first arithmetic operation unit,

the second graph information is arranged in a second memory of a second arithmetic operation unit, and

the first arithmetic operation unit performs a graph search process using the first graph information arranged in the first memory, and the second graph information arranged in the second memory.

(102)

The information processing apparatus according to (101) described above, in which

the first graph information has a size smaller than a size of the second graph information, and

the first memory has a capacity smaller than a capacity of the second memory.

(103)

The information processing apparatus according to (101) or (102) described above, in which

the first arithmetic operation unit includes a GPU or a different type of many-core arithmetic unit, and

the second arithmetic operation unit includes a CPU.

(104)

The information processing apparatus according to (103) described above, in which

the graph information is a WFST model that represents an acoustic model, a pronunciation dictionary, and a language model of speech recognition,

the first graph is a small WFST model that is a small part of two divided parts of the WFST model, and

the second graph is a large WFST model that is a large part of the two divided parts of the WFST model.

(105)

The information processing apparatus according to (104) described above, in which

the first graph information is a small WFST model produced by synthesizing the acoustic model, the pronunciation dictionary, and a small part of two divided parts of the language model, the small part considering a connection of a first number of words or smaller, and

the second graph is a large WFST model that has a language model considering a connection of any number of words larger than the first number.

(106)

The information processing apparatus according to any one of (101) to (105) described above, in which, when reference to the second graph information is necessary during execution of a search process using the first graph information, the first arithmetic operation unit copies a necessary part in the second graph information from the second memory to the first memory and continues the search process by the first arithmetic operation unit.

(107)

The information processing apparatus according to (106) described above, in which

the graph information is a WFST model,

the first arithmetic operation unit causes transition of a token on a small WFST model, and

when state transition of a token on a large WFST model is needed as a result of output of a word from an arc to which the token has transited on the small WFST model, the first arithmetic operation unit performs an entire search process while copying data necessary for the process from the second memory to the first memory.

(108)

The information processing apparatus according to any one of (101) to (107) described above, in which the first arithmetic operation unit calculates a position in the second memory beforehand, the position where a necessary arc is arranged in the second graph.

(109)

The information processing apparatus according to (108) described above, in which

the first arithmetic operation unit and the second arithmetic operation unit have a common page table, and

in response to reference to an arc contained in a page absent in the first memory by the first arithmetic operation unit, the corresponding page is transferred from the second memory to the first memory.

(110)

The information processing apparatus according to (108) described above, in which

a list of position information associated with the necessary arc and calculated by the first arithmetic operation unit beforehand is transmitted to the second arithmetic operation unit, and

the second arithmetic operation unit copies a necessary arc during graph search by the first arithmetic operation unit from the second memory to the first memory on the basis of the list.

(111)

The information processing apparatus according to any one of (101) to (110) described above, in which the first memory includes a cache that retains the second graph information.

(112)

The information processing apparatus according to (111) described above, in which the cache has a data structure that receives input of identification information indicating a source state and of an input label, and returns an arc.

(113)

The information processing apparatus according to any one of (101) to (112) described above, in which

the second arithmetic calculation unit executes feature value extraction for calculating a feature value of input speech sound, and

the first arithmetic operation unit executes HMM score calculation for calculating an HMM state score on the basis of the feature value, and a search process based on on-the-fly synthesis using the first graph information arranged in the first memory and the second graph information arranged in the second memory.

(114)

The information processing apparatus according to (113) described above, in which the second arithmetic operation unit further executes a process for outputting a speech recognition result obtained by the search process executed by the first arithmetic operation unit.

(115)

The information processing apparatus according to (114) described above, further including:

at least either a speech input unit that receives input of speech sound, or an output unit that outputs a speech recognition result.

(116)

An information processing method including:

a step of arranging, in a first memory of a first arithmetic operation unit, first graph information produced by dividing graph information;

a step of arranging, in a second memory of a second arithmetic operation unit, second graph information produced by dividing the graph information; and

a step where the first arithmetic operation unit executes a graph search process using the first graph information arranged in the first memory and the second graph information arranged in the second memory.

### REFERENCE SIGNS LIST

100: Speech recognition system
101: Feature value extraction unit
102: DNN calculation unit
103: WFST search unit
300: Speech recognition system
310: CPU
311: Main memory
320: GPU
321: Device memory
401: Signal processing unit
402: Feature value extraction unit
403: HMM score calculation unit
404: Graph search unit
405: Recognition result output processing unit
441: Speech input unit
442: Output unit
901: Large graph cache
1200: Agent system
1201: Agent device
1202: Agent service
1203: Meaning analysis unit
1211: TV
1212: Refrigerator
1213: LED light
1500: Speech recognition system
1510: CPU
1520: Memory
1530: Disk
1701: Arc array
1702: Arc indices
1703: Input label array
1801: Arc array
1802: Arc indices
1803: Input label array
1900: CPU
1901: Signal processing unit
1902: Feature value extraction unit
1903: HMM score calculation unit
1904: WFST search unit
1905: Recognition result output unit
1910: RAM
1911: Acoustic model
1912: WFST model (small)
1913: Language model arc cache
1914: WFST model (large) access data
1915: Work area
1920: SSD
1921: WFST model (large)
1931: Speech input unit
1932: Output unit
2400: CPU
2401: Signal processing unit
2402: Feature value extraction unit
2403: HMM score calculation unit
2404: WFST search unit
2405: Recognition result output unit
2410: RAM
2411: Acoustic model
2412: WFST model (small)
2413: Language model arc cache
2414: WFST model (large) access data
2415: Work area
2416: Language model access pattern model
2420: SSD
2421: WFST model (large)
2431: Speech input unit
2432: Output unit
2700: Speech recognition system
2701: Signal processing unit
2702: Feature value extraction unit
2703: HMM score calculation unit
2704: WFST search unit
2705: Recognition result output unit
2710: CPU
2720: GPU
2730: GPU memory
2731: Acoustic model
2732: WFST model (small)
2733: language model arc cache
2734: WFST model (large) access data
2735: Work area
2736: Language model access pattern model
2740: SSD
2741: WFST model (large)
2751: Speech input unit
2752: Output unit

1. An information processing apparatus comprising:
an arithmetic operation unit;
a first storage device; and
a second storage device, wherein
graph information is divided into two parts constituted by first graph information and second graph information,
the first graph information is arranged in the first storage device,
the second graph information is arranged in the second storage device, and
the arithmetic operation unit executes a graph search process using the first graph information arranged in the first storage device and the second graph information arranged in the second storage device.

2. The information processing apparatus according to claim 1, wherein
the first graph information has a size smaller than a size of the second graph information, and
the first storage device has a capacity smaller than a capacity of the second storage device.

3. The information processing apparatus according to claim 2, wherein
the graph information is a WFST (Weighted Finite State Transducer) model that represents an acoustic model, a pronunciation dictionary, and a language model of speech recognition,
the first graph is a small WFST model that is a small part of two divided parts of the WFST model, and
the second graph is a large WFST model that is a large part of the two divided parts of the WFST model.

4. The information processing apparatus according to claim 3, wherein
the first graph information is a small WFST model produced by synthesizing the acoustic model, the pronunciation dictionary, and a small part of two divided parts of the language model, the small part considering a connection of a first number of words or smaller, and
the second graph is a large WFST model that has a language model considering a connection of any number of words larger than the first number.

5. The information processing apparatus according to claim 1, wherein, when reference to the second graph information is necessary during execution of a search process using the first graph information, the arithmetic operation unit copies a necessary part in the second graph information from the second storage device to the first storage device and continues the search process.

6. The information processing apparatus according to claim 1, wherein
the arithmetic operation unit includes a first arithmetic operation unit including a GPU (Graphics Processing Unit) or a different type of many-core arithmetic unit, and a second arithmetic operation unit including a CPU (Central Processing Unit),
the first storage device is a memory in the GPU, and
the second storage device is a local memory of the CPU.

7. The information processing apparatus according to claim 6, wherein
the graph information is a WFST model,
the first arithmetic operation unit causes transition of a token on a small WFST model, and
when state transition of a token on a large WFST model is needed as a result of output of a word from an arc to which the token has transited on the small WFST model, the first arithmetic operation unit performs an entire search process while copying data necessary for the process from the second storage device to the first storage device.

8. The information processing apparatus according to claim 6, wherein the first arithmetic operation unit calculates a position in the second storage device beforehand, the position where a necessary arc is arranged in the second graph.

9. The information processing apparatus according to claim 8, wherein
the first arithmetic operation unit and the second arithmetic operation unit have a common page table, and
in response to reference to an arc contained in a page absent in the first storage device by the first arithmetic operation unit, the corresponding page is transferred from the second storage device to the first storage device.

10. The information processing apparatus according to claim 8, wherein
a list of position information associated with the necessary arc and calculated by the first arithmetic operation unit beforehand is transmitted to the second arithmetic operation unit, and
the second arithmetic operation unit copies a necessary arc during graph search by the first arithmetic operation unit from the second storage device to the first storage device on a basis of the list.

11. The information processing apparatus according to claim 1,
wherein the first storage device includes a cache that retains the second graph information.

12. The information processing apparatus according to claim 11, wherein the cache has a data structure that receives input of identification information indicating a source state and of an input label, and returns an arc.

13. The information processing apparatus according to claim 5, wherein
the information processing apparatus is applied to a speech recognition process,
the information processing apparatus executes feature value extraction that calculates a feature value of input speech sound using the second arithmetic operation unit, and
the information processing apparatus executes, by using the first arithmetic calculation unit, HMM (Hidden Markov Model) score calculation for calculating an HMM state score on a basis of the feature value, and a search process based on on-the-fly synthesis using the first graph information arranged in the first storage device and the second graph information arranged in the second storage device.

14. The information processing apparatus according to claim 13, wherein the information processing apparatus further executes, by using the second arithmetic operation unit, a process for outputting a speech recognition result obtained by the search process executed by the first arithmetic operation unit.

15. The information processing apparatus according to claim 4, wherein
the first storage device is a local memory of the arithmetic operation unit,
the second storage device is an auxiliary storage device,
the arithmetic operation unit causes transition of a token on a small WFST model, and
when state transition of a token on a large WFST model is necessary as a result of output of a word from an arc to which the token has transited on the small WFST model, the arithmetic operation unit performs the search process while copying data necessary for the process from the second storage device to the first storage device.

16. The information processing apparatus according to claim 15, wherein
the first storage device retains data for accessing the large WFST model in the second storage device, and
the arithmetic operation unit copies the data necessary for the process from the second storage device to the first storage device on a basis of the data for accessing.

17. The information processing apparatus according to claim 16, wherein
the large WFST model includes an arc array where arcs are sorted on a basis of a state ID of a source state and an input label,
the first storage device includes arc indices that store start positions of arcs in respective states in the arc array as the data for accessing, and an input label array that stores input labels corresponding to the arcs in the arc array and arranged in an array identical to the arc array, and
the arithmetic operation unit specifies a position where a target arc in the arc array is stored, and acquires data of the target arc from the arc array of the second storage device by specifying a start position of a state ID of a source state of the target arc in the arc array on a basis of the arc indices, and searching an input label of the target arc on a basis of an element at the start position in the input label array.

18. The information processing apparatus according to claim 16, wherein
the large WFST model includes an arc array where arcs are sorted on a basis of a state ID of a source state and an input label,
the first storage device includes arc indices that store start positions of arcs in respective states in the arc array as the data for accessing, and an input label array that stores input labels of initial elements in the arc arrays in pages each separating the arc array, and
the arithmetic operation unit calculates a page range where a target arc is present on a basis of the arc indices, specifies a page where the target arc is present from the page range on a basis of the input label array, and acquires the specified page from the arc array of the second storage device.

19. The information processing apparatus according to claim 17, further comprising:
an access pattern model for predicting an arc or a page highly likely to be accessed next on a basis of a previous access history to arcs, wherein
the arithmetic operation unit pre-reads an arc or a page predicted on a basis of the access pattern model from the second storage device.

20. An information processing method performed by an information processing apparatus that includes an arithmetic operation unit, a first storage device, and a second storage device, the information processing method comprising:
a step of arranging, in the first storage device, first graph information produced by dividing graph information;
a step of arranging, in the second storage device, second graph information produced by dividing the graph information; and
a step of executing, by the arithmetic operation unit, a graph search process using the first graph information arranged in the first storage device and the second graph information arranged in the second storage device.
